(19) United States
(12) Patent Application Publication
(10) Pub. No.: US 2017/0282228 A1
(43) Pub. Date: Oct. 5, 2017

(54) METHOD AND MEANS FOR TREATMENT OF SOIL

(71) Applicant: DE NATIONAL GEOLOGISKE UNDERSØGELSER FOR DANMARK OG GRØNLAND, Copenhagen K (DK)

(72) Inventors: Knud Erik Klint, Copenhagen K (DK); Claus Kjøller, Copenhagen K (DK); Hans Jørgen Lorentzen, Copenhagen K (DK); Mads Terkelsen, Hillerød (DK)

(73) Assignee: DE NATIONAL GEOLOGISKE UNDERSØGELSER FOR DANMARK OG GRØNLAND, Copenhagen K (DK)

(21) Appl. No.: 15/507,428

(22) PCT Filed: Sep. 24, 2015
(86) PCT No.: PCT/EP2015/071947

§ 371 Date: Feb. 28, 2017

(30) Foreign Application Priority Data
Sep. 24, 2014 (EP) PCT/EP2014/070413

(51) Int. Cl. B09C 1/06; E02D 3/115; B09C 1/02

(52) U.S. Cl. CPC B09C 1/06; B09C 1/02; E02D 3/115; B09C 2101/00

(57) ABSTRACT

Disclosed is a method for introducing a liquid, preferably aqueous, into a volume of a porous medium (typically clay or clay-rich soil), which has a matrix hydraulic conductivity below 10⁻⁷ m/s, comprising establishing at least one frozen section and at least one non-frozen section of said volume and introducing said liquid into said non-frozen section. Also disclosed is a method for remediation of a volume of such a porous medium as well as a system/assembly suitable for carrying out said method.

### FIELD OF THE INVENTION

The present invention relates to the field of “in situ” remediation of contaminated low permeable deposits/soils. In particular, the present invention relates to a novel method for facilitating transport of liquids (typically aqueous) into/through low permeability soils and deposits, thereby providing an improvement in remediation of polluted soils and deposits. The invention also relates to a system suitable for carrying out the method of the invention.

### BACKGROUND OF THE INVENTION

Remediation of contaminated soil is generally costly and resource consuming. In certain prior art methods, it has been attempted to create a barrier or wall that traps the contaminated volume of soil to avoid spreading of contamination to the surrounding non-contaminated soil. In some of these prior art methods, the contaminated volume is walled-in completely, for instance by freezing a surrounding section of soil, thus allowing the trapped volume to be treated with remediation techniques or in some cases to be removed and deposited and/or treated in a distant location—such a technology is disclosed in U.S. Pat. No. 5,730,550 and in US 2004/0120772.

U.S. Pat. No. 5,416,257 relates to a related approach where open frozen barriers are created in soil so as direct the flow of contamination which may be carried by a liquid (e.g. groundwater), which is pumped into the contaminated area. In these methods, the added liquid is used to enhance migration of the contaminants in the soil.

Another approach is presented in U.S. Pat. No. 5,324,137 where a freeze front is “swept” through a soil volume. This causes concentration of contaminants in the freeze front area, from which they are subsequently removed in a collection zone.

However, in situ remediation in low permeable deposits is generally restricted by the very low matrix hydraulic conductivity. Since the dominating transport mechanism in massive fine-grained deposits such as clay is diffusion, contamination may remain in the matrix for several hundred years.

Until now, the primary challenges have been to distribute donor compounds, capable of stimulating natural attenuation of the contamination, homogenously in the matrix.

Generally, matrix hydraulic conductivity in clayey deposits is very low (ranges below 1×10⁻¹⁰ m/s are not uncommon). The main process of transport in these deposits is diffusion. Diffusion rates depend on relative concentrations, temperature and distance towards areas of higher permeability, constituted by macro pores, such as fractures or sand lenses, where the contamination may be degraded or extracted. Generally distances exceeding 10-20 cm require many years in order to reduce the concentration of contamination in the matrix significantly.

The extraction and/or degradation of contaminants are accordingly very slow processes and there is a need for enhancing the rate of transport in order to accelerate the remediation process. Several in situ remediation/stimulation technologies have been tested over time:

For instance, various in situ treatment technologies (bio remediation, soil vapour extraction, ventilation, oxidation) combined with physical stimulation such as pneumatic fracturing, hydraulic fracturing, blasting, soil mixing, jet-injection, etc. and thermal treatment have been applied with various degrees of success. The most efficient method known today is the thermal treatment where the contaminated soil is heated to above the boiling point of the contaminated water—this is e.g. the suggested remediation technique in US 2004/0120772. However, this method is very energy consuming and results in sterilization of the soil treated.

The main problem with current technologies is that the superior methods are very expensive while the cheaper technologies are less effective.

The main challenge with injection and fracturing technologies is the problem of creating a dense network of soil fractures with a preferable maximum distance between the fractures of 10-20 cm in order for the transport of the contaminated water to occur within an acceptable timeframe.

To conclude, it remains a problem to artificially create a dense network of fractures in soil and it has consequently not been determined whether generation of such fractures can at all facilitate remediation of polluted soils.

### OBJECT OF THE INVENTION

It is an object of embodiments of the invention to provide improved methods that facilitates remediation of soils and deposits, in particular those that are densely packed and exhibit a very low natural conductivity for liquids such as water. It is also an object to provide a system and means for effecting such remediation.

### SUMMARY OF THE INVENTION

Natural soil fractures with a small spacing are generally restricted to fractures formed by desiccation and or freeze thaw processes in the soil. This is a well-known and well described process occurring naturally almost everywhere in cold or dry regions. Clay deposits are often densely fractured in the upper (surface-proximal) parts, and hydraulic tests have revealed bulk hydraulic conductivities in the order of 1×10⁻⁶ to 1×10⁻⁴ m/s, which are several orders of magnitude higher than the conductivities measured in massive clayey deposits.

This fact motivated the present inventors to experiment with freezing of clay in order to create dense networks of fractures that would potentially increase the bulk hydraulic conductivity and allow for introduction of various treatment technologies.

However natural freeze thaw fractures have been formed during thousands of years and annual cycles. Reproducing the same type of hydraulically active fractures within a reasonable timespan and at a low cost (depending on the number of freezing cycles) presented a primary challenge. Generally, multiple intact samples (both contaminated and clean) of different clayey soil types were collected and frozen in a laboratory setting. The primary parameters tested were: clay content, absolute temperature, freezing speeds, sample size, water content, and number of freezing cycles in order to determine the best procedure for creating the optimal fracture networks. The formation of freeze thaw fractures was described during all the experiments and permeability of samples was measured on cores in order to document the hydraulic effect of freezing.

Finally after more than two years of experiments the present inventors found the optimal recipe for fracturing clayey soils by freezing, but in addition a very important and surprising discovery was made.

By freezing the clay-rich sediment and at the same time passively adding water nearby (outside the frozen part of the soil), a very rapid transport (tens of cm pr. day) from the water addition point/area towards the freezing front was observed. Subsequent experiments furthermore documented that donor added to (and contained in) the water is likewise transported rapidly through the massive matrix, thus enabling an enhanced natural degradation of contamination within the matrix. This is the primary discovery that has led to the present invention.

The present invention is hence based on the surprising demonstration that the formation of freeze/thaw fractures in order to increase the bulk hydraulic conductivity of massive clay and clay till is accompanied by a surprising and extremely fast transport of water from the unfrozen clay towards the freezing front of the frozen clay. By adding water mixed with a donor to the unfrozen area during the freezing experiment large quantities of donor were rapidly distributed within the clay matrix. Numerous experiments with different samples with different clay content, absolute temperature, freezing velocities, sample size, water content and number of freezing cycles were performed in order to determine the best procedure for creating the optimum distribution of donor and hence the most effective remediation of the contaminated clay. Furthermore the technology was adapted to installed wells in the clay.

The “cryo remediation” technique provided by the present invention thus falls within a large number of technologies developed for in situ stimulation and remediation of contaminated low permeable deposits/soils. The invention facilitates transport of donor mixed with (aqueous) fluids by freezing low permeable sediment and supply liquids in a nearby location in the sediment.

So, in a first aspect the present invention relates to a method for distributing a liquid medium into a volume of a porous medium, which has a matrix hydraulic conductivity below 10⁻⁷ m/s, comprising establishing at least one frozen section and at least one non-frozen section of said volume and introducing said liquid into said non-frozen section.

A second aspect relates to a method for reducing the concentration of polluting material in a volume of a porous medium, which has low matrix hydraulic conductivity below 10⁻⁷ m/s, comprising distributing a liquid medium in said volume according to the method of the first aspect of the invention for a period of time sufficient to reduce the concentration of the polluting material to a predetermined value

A third aspect relates to a system for introducing a liquid medium into a volume of a porous medium, which has low matrix hydraulic conductivity below 10⁻⁷ m/s, said system comprising
at least one freezing unit inserted into said volume and being capable of establishing a frozen section of said volume,
at least one delivery means inserted into said volume and being adapted to supply a liquid medium into a non-frozen section of said volume while a section of said volume is frozen in a section comprising said at least one freezing element,
at least one first temperature gauge inserted into said volume in close proximity to said at least one freezing element, and
at least one second temperature gauge inserted into said volume in close proximity to said at least one delivery means.

### LEGENDS TO THE FIGURE

FIG. 1: “Sous Vide Pot” experimental setup.

An intact clay till sample is placed in a sous vide pot in order to control temperature and establish a temperature gradient similar to natural conditions.

FIG. 2: Picture of freeze thaw fractures at two different temperature intervals. In both intervals the top of the container is maintained at −15° C., whereas the bottom temperature is maintained at 5° C. and 4° C., respectively. The graph shows the temperature curves measured from the 3 temperature measuring probes shown in FIG. 1 (Probe A is gauging the temperature in the water supply, Probe B between water supply and frozen surface, and Probe C near and inside the frozen surface). The large variation in measurements in probe A are due to the frequent reactions in the water supply thermostat.

FIG. 3: Graph showing the water consumption during deuterium freezing experiments with the Sous Vide setup. At the time freezing starts in the clay, a dramatic increase in water consumption by the clay till sample is observed.

FIG. 4: Graphs showing concentrations of deuterium and molasses in cross sections of the matrix sampled. Results confirm that the substances are transported in a fluid (not gaseous) phase through the massive unfrozen matrix and accumulate in the unfrozen area and where the ice-lenses are formed. The uppermost part of the sample includes less donor substance due to rapid/early freezing

A. Deuterium/¹⁸O.

B. Molasses and Br.

FIG. 5. Collection of 2 LUC (large undisturbed columns) samples.

The columns were carefully excavated in a large open pit and captured in a cylinder before being transported to the inventors' laboratory.

FIG. 6: Large undisturbed column of clay till (50×60 cm) with central cooling pipe and 4 liquid injection points.

FIG. 7: Pictures of the LUC sample experimental setup from Example 3.

A. A LUC sample in the cylinder with the central freezing pipe inserted.

B. The water supply system.

C. The frozen LUC1 sample with the frozen central part, which is clearly distinct from the surrounding non-frozen part of the sample. The circular freezing front is marked with dots at a distance from the centre, which is approximately half of the diameter of the cylinder.

FIG. 8: Freezing curves from thermosensors 1 and 5.

A. In LUC1, and

B. In LUC2.

FIG. 9: Water consumption in LUC1 and LUC2 during the freezing experiment.

The experiment was running for more than 500 hours (LUC1) and 1200 hours (LUC2).

However water consumption continued as did expansion during the full duration of the freezing experiment as long as water was added.

FIG. 10: Temperature measurements in the LUC2 experiment at three different temperature gradients as well as at initial conditions before initiating the freezing process (black curve).

FIG. 11: Distribution of donor substance in LUC samples.

The freezing experiment with the LUC samples show that the donor substance model (deuterium) is fully distributed in the matrix between the freezing and injection areas. The concentration decreases towards the freezing front due to early freezing (reduced transport) close to the freezing pipe.

FIG. 12: Picture of experimental setup in an undisturbed clayey till under natural conditions.

FIG. 13: Picture of the interior of container with freezing equipment, water/donor injection system, temperature monitoring system, and data logger for water consumption and temperature measurements.

FIG. 14: Schematic presentation of configuration of a central freezing well surrounded by 9 injection wells (1A-5A and 1B-4B) and 15 thermistors (C1-C15).

FIG. 15: Picture of soil sample taken from the experiment described in Example 4.

FIG. 16: Graph showing the time vs. freezing zone radius relationship in a soil freezing experiment.

FIG. 17: Graph showing water consumption in all wells surrounding a freezing well.

FIG. 18: Graph showing water consumption in 2 selected wells from FIG. 17.

FIG. 19: 3D graph showing bromide concentrations in different sections of

FIG. 20: Graph showing the elevation of soil surface an area treated according to the invention.

FIG. 21: Schematic depiction of an embodiment of the invention utilising a plurality of cooling elements (pipes) and supply elements (perforated pipes) for liquid/donor.

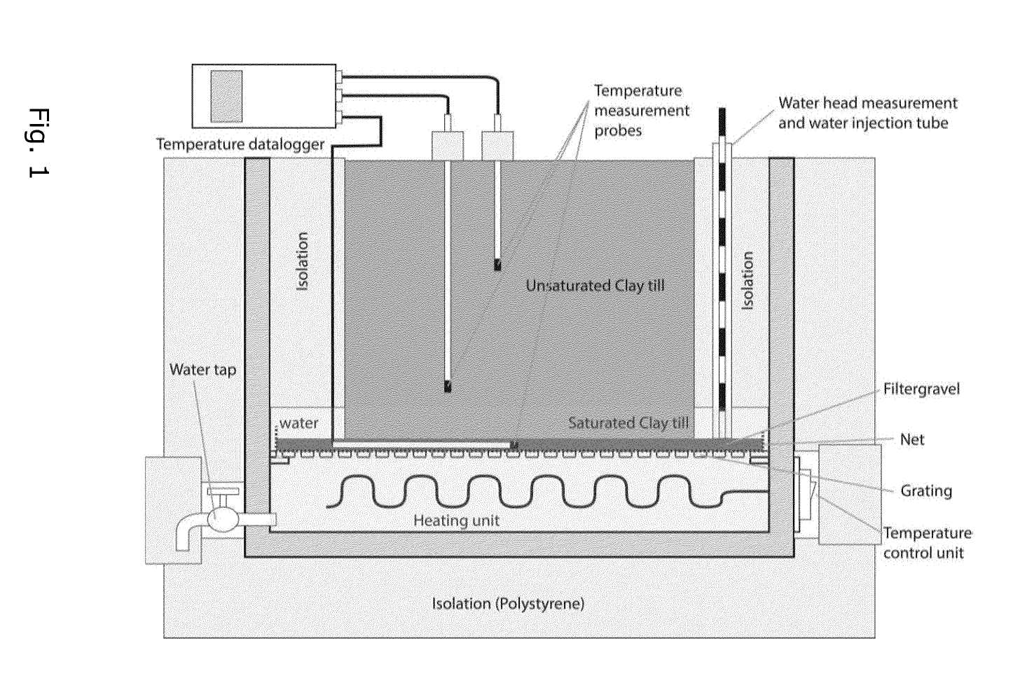

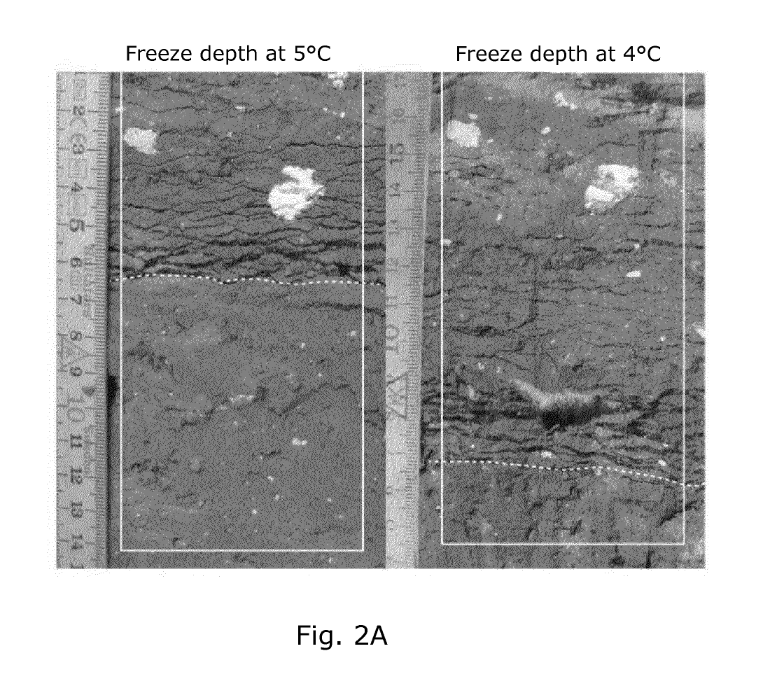

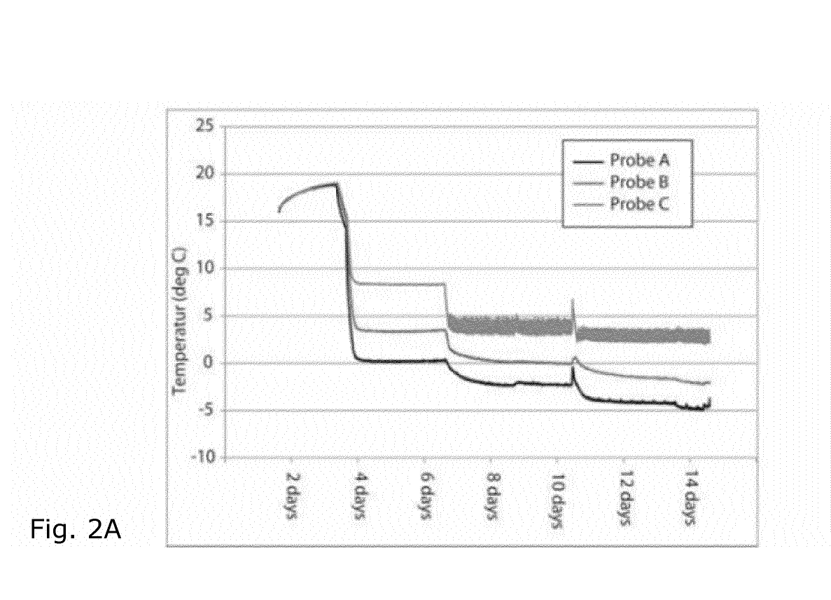

### DETAILED DISCLOSURE OF THE INVENTION

### Definitions

A “liquid medium” generally means any liquid solvent, optionally containing solutes, but for most practical purposes, a liquid medium is a water-based, i.e. aqueous medium, which under normal circumstances permeates through clay at low speed, typically via diffusion.

A “porous medium having a low hydraulic conductivity” is in the present context a grained medium such as claim, which is so densely packed that the hydraulic conductivity does typically not exceed 10⁻³ m/s when the porous medium is in a non-frozen state and does not contain any frozen sections. In the present context, a “soil volume” is a specific example of such a porous volume and denotes a volume of soil in situ, typically rich in clay and therefore very compact and having a low hydraulic conductivity. The soil volume may be polluted or contaminated, e.g. as a consequence of chemicals that has filtered down from surface soils. The term “soil” generally also embraces within its scope various sediments or deposits found in the ground.

The low hydraulic conductivity of typically less than 10⁻⁷ m/s but can be considerably lower, since the presently disclosed methods have proven effective in facilitating water transport in materials that exhibit very low hydraulic conductivities. Hence, according to the invention, the hydraulic conductivity in the volume subjected to the method(s) can be less than 10⁻⁸ m/s or less than 10⁻⁹ m/s or less than 10⁻¹⁰ m/s or even less than 10⁻¹¹ m/s.

“Clay” is a term which denotes soil that has a specific grain size in the clay fraction. The most outspread is: Lacustrine clay deposited in lakes, marine clay deposited in marine environments and poorly sorted sediment with more than 12% clay referred to as a clay diamict or if deposited in contact with a glacier clay till, which is the most widespread sediment type in Denmark and accordingly also the clay type that includes the majority of contaminated sites in Denmark.

Clay may be formed globally, while clay till is generally widespread throughout the former glaciated areas on the northern hemisphere including USA, Canada, Scandinavia, The Baltic countries, Russia, Poland, Germany, the Netherlands and UK+around mountains/high ground that was glaciated in the Ice ages.

A “freezing unit” is in the present context a device, which may be introduced into clay-rich soil and cool soil surrounding the device to temperatures below 0° C. The physical form and shape of such a freezing unit may vary considerably, but in some cases it is constituted by liquid containing pipes, where the liquid has been brought to a temperature <0° C. and where the pipes and the unit in general is made from a material having a high heat conductivity. The freezing unit may also be shaped in various different forms suited to create a desired profile of a freezing front, e.g. as panels or a meshwork.

A “freezing front” is in the present context the demarcation between frozen and non-frozen soil in the soil volume.

“Freeze/thaw” fractures are fractures formed in clay and clay-rich soils at temperatures below 0° C. In nature they appear as the consequence of repeated freezing and thawing of clay during the winter, whereby water assembles as ice lenses during the freezing process that expands and form fractures in the clay.

### SPECIFIC EMBODIMENTS OF THE INVENTION

In the first aspect of the invention, i.e. the method for distributing a liquid medium into a volume of a porous medium, which has a low matrix hydraulic conductivity, typically below 10⁻⁷ m/s, comprising establishing at least one frozen section and at least one non-frozen section of said volume and introducing said liquid into said non-frozen section, the volume consists of or comprises a porous medium having a low hydraulic conductivity. As discussed above, such porous media cannot readily be supplied with water or other liquids in connection with remediation processes, whereas the present invention facilitates the supply of liquid.

In related situation where the hydraulic conductivity for some reason is higher than 10⁻⁷ m/s (cf. above), it is not normally a problem to introduce a remediation liquid meaning that the present invention provides for less evident improvements, but even in those types of situations, the formation of fractures in the volume may facilitate influx of remediation liquids due to the capillary forces that cause the influx. However, the invention is as will be understood from the above, in particular useful when the method is carried out in soils and other porous matrices, where the hydraulic conductivity is very low.

Typically, the volume of the porous medium comprises or consists of clay or clay-rich material, but other materials that share the low hydraulic conductivity may also benefit from the present invention: low conductivity sediments, primarily clay/silt is one example. Also biogenic rock types, such as limestone or cemented sedimentary rocks (shale, sandstone) can be supplied with liquid according to the present invention. It is also contemplated that at least some porous crystalline rock types can be supplied with liquid according to the invention.

It will be understood—i.a. on the basis of the examples below—that the exact means and methods for freezing sections of the volume and/or for supplying liquid to the non-frozen part of the volume are inessential and can take many forms primarily dictated by convenience or optimization. The small-scale experiments set forth in the Examples herein have for instance utilised a model where an entire volume of soil has been frozen from the top (using the air temperature the means for freezing) while kept above freezing point in the bottom, where water has been supplied, whereas the larger scale experiments have utilised a freezing element introduced vertically into a soil sample while the temperature has been kept above freezing point in vertical sections at some distance from the frozen core. Nevertheless, both designs have been successfully put into practice, thus evidencing that the geometry can be varied.

In most practical embodiments, it is nevertheless preferred that frozen section(s) is/are established by means of at least one freezing unit introduced directly into said volume, i.e. in a manner similar to that of Example 3 below. Such freezing units may have any physical shape, which suits the purpose of establishing a frozen section surrounding the freezing unit: pipes, panels, or meshwork that can absorb heat from the surroundings each provide advantages in terms of the shape of freezing fronts and area of contact with non-frozen areas.

In the practice of the invention it has been found that presence of liquid, e.g. aqueous liquid, already at the onset of the freezing of sections in the volume provides for an advantageous expansion of the frozen section, formation of fractures and hence of supply of liquid. Hence, in embodiments it is preferred that the liquid medium is introduced already while the at least one frozen section is being established or even prior to this time point. Also, the liquid medium is conveniently introduced after the at least one frozen section has been at least partially established, meaning that certain embodiment entail that the liquid medium is added during the entire freeze process.

As mentioned above, one important feature that appears to drive the transport of liquid is the volume expansion of the frozen section as a consequence of the freezing process, so in certain embodiment, this volume expansion is optimized and controlled during the operation of the method. Preferably this volume expansion is at least 3%, but higher percentages are also advantageous, such as at least 4, 5, 6, 7, 8, 9, 10, 11, 12, 13, 14, 15, 16, 17, 18, 19, 20, 21, 22, 23, 24 or even at least 25% volume expansion. Such expansion increases the capacity for the liquid medium in the frozen section, probably because of the formation of expanding ice lenses in the frozen section.

The freezing should as a rule not give rise to freeze/thaw fractures that exhibit a wider spacing than at most 20 cm, but in preferred embodiments the freeze-thaw fractures created in the frozen section should be spaced with an average distance of at most 10 cm, such as at most 9, 8, 7, 6, 5, 4, 3, 2 or at most 1 cm.

Introduction/supply of the liquid medium to the non-frozen section can be achieved in a number of ways—the important goal to achieve is the substantially continuous presence of the liquid being in contact with the non-frozen section. In some embodiments, the liquid medium is introduced into the non-frozen section at elevated pressure—this can e.g. be achieved by introducing water supplying means (perforated pipes, panels, meshwork) into the non-frozen section and applying the liquid from a column of a certain height so that a constant pressure is present at the same depth in the non-frozen column. In some volumes (e.g. stable volumes of clay), it may be possible to simply add liquid by pouring/filling directly into a “naked” bore hole, i.e. omitting the need for any piping or other device that in other embodiments may stabilize the walls in a bore hole.

As will be understood from the above, the liquid medium moves from its point(s) of introduction in the at least one non-frozen section in the direction of the at least one frozen section. Hence, the operation of the method may be controlled by measuring the rate of liquid addition—the rate will at some time point approach zero when the capacity for the liquid medium has been reached in the frozen sections. This time point will normally define the end of the conditions, under which the liquid movement is mainly driven by capillary forces in said non-frozen section in the direction toward the frozen section.

The method of the first aspect may be performed repeatedly on the same volume to further increase the supply of liquid: the method may comprise at least two separate rounds, wherein at least one subsequent round establishes 1) at least one frozen section in a part of the volume that constituted a non-frozen section in the previous round and 2) at least one un-frozen section in a part of the soil volume that constituted a frozen section in the previous round. As shown in the Examples, the supply of liquid to the parts of a (soil) volume that freezes early in the process is less effective than the supply to later frozen or unfrozen parts. Therefore, if the process is reversed one or several times by adding liquid to a previously frozen section while freezing a previously unfrozen section would be expected to result in a more even and complete distribution of liquid in the entire volume. One way of achieving this shift in conditions would be to arrange freezing units and liquid supply means in close proximity and then operate the freezing and liquid addition in a way that will create alternating sections of frozen vs. un-frozen sections, where the liquid supply to the non-frozen sections is maintained while the nearby freezing units are “turned off” whereas freezing units further away are turned on while no water is supplied from the water supply means in their proximity.

At any rate, in practical implementations of the method of the first aspect, a plurality of frozen sections is established and/or a plurality of non-frozen sections is established.

The distance between a point of introduction of liquid medium and the nearest frozen section is for practical reasons typically (but not necessarily) at least 30 cm (e.g. at least 1 m), but the distance should on the other hand not be so far that the flow of liquid in any part of the non-frozen section will be limited by the distance to the nearest frozen section.

In many embodiments of the first aspect of the invention, the at least one frozen section is cylindrical—this is the typical geometry obtained when the freezing units introduce are pipes or other cylindrically shaped objects. However, since it may be advantageous to increase the area of contact between the frozen section and the non-frozen section (in other words, increasing the area of the freezing front), other geometries are also possible. For instance, if more than one frozen section is established it may be separated from other non-frozen sections by wall shaped non-frozen sections. Such wall-shaped sections may form closed walls, e.g. concentric cylindrical walls, or form spaced open walls, e.g. parallel walls, but any geometry may find practical use and will essentially depend on the physical shape of the freezing units employed.

The preferred liquid in the liquid medium is aqueous, but non-aqueous liquids may be useful under certain circumstances.

In most embodiments, the liquid medium comprises a solubilised or dispersed donor substance or composition, which is capable of being distributed freely into the volume together with the liquid medium. Typically this donor will be an active principle that upon its distribution into the volume will facilitate degradation of undesired substances present in the volume. Such donor substance and compositions are well-known for the person skilled in the art and may be selected from microorganisms such as bacteria, enzymes, catalysts, nano-particles such as nano iron, oxidizing agents such as permanganates, salts, hydrocarbons, and carbohydrates.

The porous medium subjected to the method of the first aspect of the invention is often a volume of soil, but may also be a sediment (typically clay/silt), or biogenic rock such as limestone or cemented sedimentary rocks (shale, sandstone), or porous crystalline rock. All these types of matrices have very low hydraulic conductivities, whereby they are conveniently treated according to the invention.

The method of the first aspect may be carried out for a number of purposes. One important purpose is—as apparent from the above discussion and the examples—remediation of polluted porous media but in other cases it may simply be of interest to infuse liquid and solutes or dispersed material into the porous medium. One reason for doing this may be to solidify a matrix, which exhibits low hydraulic conductivity but which is not suitable for a purpose that requires a solid substance. An example would be impregnation of clay (or other material) with a polyester resin, thus rendering it possible to cast intact samples in order to perform detailed analyses of the internal structures in the samples. The current technology for obtaining a cast sample of clay for this purpose involves freeze-drying of the clay, a process that takes several months—this would be expected to be reduced considerably if the resin were to be introduced via the method of the first aspect of the invention.

As demonstrated in Example 4, the method may be optimized if the addition of liquid to the volume treated is controlled so as to avoid influx of water from external, e.g. natural, sources. By ensuring this, it is avoided that e.g. precipitation (rain etc.) is introduced into the volume whereby the liquid intended for introduction is diluted. One simple way to achieve this effect is by covering the surface exposed area of the volume that is treated.

Closely related to the first aspect of the invention is the second aspect, i.e. a method for reducing the concentration of polluting material in a volume of a porous medium, which has low matrix hydraulic conductivity, typically below 10⁻⁷ m/s, comprising distributing a liquid medium in said volume according the method of the first aspect of the invention for a period of time sufficient to reduce the concentration of the polluting material to a predetermined value. As will be understood from the above, the reduction in concentration of said polluting material is facilitated by inclusion of a donor substance or composition discussed in detail above.

The third aspect of the invention relates to a system (or assembly) for introducing a liquid medium into a volume of a porous medium, which has low matrix hydraulic conductivity, typically below 10⁻⁷ m/s, said system comprising
at least one freezing unit inserted into said volume of the porous medium and being capable of establishing a frozen section of said volume,
at least one delivery means inserted into said volume and being adapted to supply a liquid medium into a non-frozen section of said volume while a section of said volume is frozen in a section comprising said at least one freezing element,
at least one first temperature gauge inserted into said volume in close proximity to said at least one freezing element, and
at least one second temperature gauge inserted into said volume in close proximity to said at least one delivery means.

In typical embodiments, the system will comprise a plurality of freezing units and/or a plurality of delivery means, thus facilitating the use of the system/assembly for remediation of larger volumes of polluted soil and other large volumes of porous material.

The temperature gauges serve to deliver output relating to the current temperatures in a frozen and non-frozen section and this output can in turn be used to control the rate of the freezing process in the method of the first and second aspects of the present invention so as to optimize these processes. Typically, the operation may be automated or semi-automated, meaning that the freezing unit(s) constitute(s) part of a closed controlled circuit, which can maintain a predetermined temperature below freezing point of said freezing unit(s) and the surrounding volume and which can maintain a temperature above freezing point in medium surrounding said delivery means in response to temperature measurements from said at least one first and second temperature gauges.

The freezing units may be in any suitable physical shape, but often in the form of pipes, panels, or a meshwork, optionally inserted vertically into said volume. Likewise, the delivery means is/are in the form of perforated pipes, perforated panels, or a perforated meshwork, optionally inserted vertically into said soil volume. The perforation ensures that liquid may pass into the volume—hence, instead of perforation, the delivery means may be formed from a material which is permeable for the liquid medium and any solutes or dispersed agents that are present therein.

In general, the system/assembly may be operated in order to carry out all embodiments of aspects 1 and 2 of the invention. This means that all considerations discussed with respect to the physical form and exercise of these two aspects apply mutatis mutandis for the operation and design of the system/assembly.

### Example 1

### Creation of Freeze/Thaw Fractures and Ice Lenses During Freezing of Intact Samples of Contaminated Clayey and Sandy Tills in an Open System

Rationale/goal: The goal of this experiment was to measure specific parameters in order to optimize the setup of large scale experiments. Since the potential contaminated soils have different properties in terms of bulk hydraulic conductivity, grain size distribution and fate/concentration of contamination, it is important to gain knowledge of the following information:

1. How fast is freeze/thaw fractures formed in contaminated clayey and sandy tills?

2. At which specific temperature ranges are the fractures formed in contaminated clayey and sandy tills?

3. How much water is transported towards the freezing point in a well-defined volume pr. time unit in contaminated clayey and sandy tills?

4. How much does the clay content influence the migration of the freezing front and the formation of the freeze/thaw fractures in contaminated clayey and sandy tills?

### Methods

Imitating natural conditions in an open system by simulating the migration of a freezing front into the subsurface under natural conditions was conducted using a so-called “Sous Vide Pot”, which basically is a water bath manufactured for cooking vacuumed meat at a very specific temperature for a long period.

A large intact sample of clay till (20×20×25 cm) was placed in the sous vide pot on a layer of gravel. Temperature probes connected to a data logger were installed in the clay till sample for monitoring the development of a freezing front. The lower part of the sample is resting in water kept at a constant temperature of typically 5° C. The clay till sample and the entire pot were isolated by polystyrene except on the top, which was fully exposed to air. Finally the setup was placed in a freezing room with constant temperature at −15° C. The water level in the Pot was kept close to constant by addition of water during the freezing experiment. The amount of added water was monitored as well as the vertical expansion of the clay till block. The experiment was repeated with different types of clay tills in order to evaluate the impact of the clay content on the migration of the freezing front and the absorption of water.

After the end of each freezing experiment the frozen block was carefully removed and photographed. Selected core samples of frozen and unfrozen till were collected for analysis of water content.

### Results

1. How fast are freeze/thaw fractures formed in contaminated clayey and sandy tills? Answer: At the scale of the Sous Vide experiments, equilibrium is maintained within 1 day. The ice lenses continue to grow as long as water is added and the temperature maintained.

2. At what specific temperature ranges are the fractures formed in contaminated clayey and sandy tills?

Answer: Fractures and ice lenses are formed at temperatures starting at −1° C. and continues to grow at temperatures below at least −10° C. Ice-lenses at lower temperatures close to the surface tend to start evaporating (by sublimation). Any substance (donor) contained in the ice should accordingly be left in the matrix.

3. How much water is transported towards the freezing point in a well-defined volume pr. time unit in contaminated clayey and sandy tills?

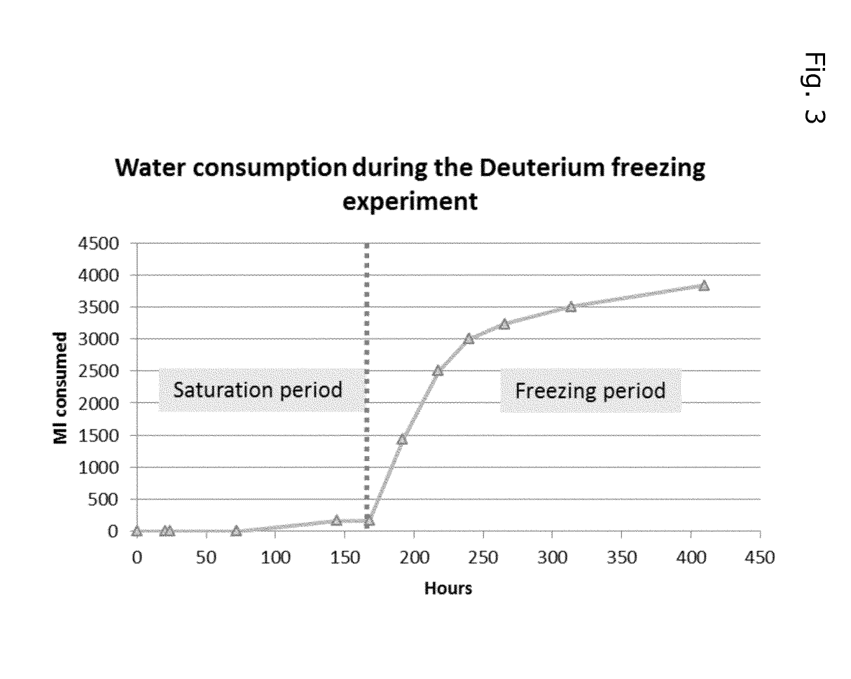

Answer: As much as 35% volume (350 ml/dm³) was consumed by the clay samples over a period of 150 hours, which corresponds to between 1 and 3 ml/dm³/hour (see FIG. 3).

4. How much does the clay content influence the migration of the freezing front and the formation of the freeze/thaw fractures in contaminated clayey and sandy tills?

Answer: Clay rich till absorb more water than sandy till. Generally clay till also has a deeper freezing front indicating a different temperature gradient.

### Example 2

Experiment with Transport of Tracer/Donor (Deuterium/¹⁸O/Br/Molasses) During Freezing of Intact Samples of Sandy Clay Till in an Open System

Rationale/goal: The transport of fluids in the soil during the freezing process should preferably be in an aqueous phase and not in a gaseous phase since phase transformation may result in a distillation process preventing the donor to be distributed equally in the frozen soil. The goals of this experiment are accordingly:

1. To determine whether the transport of water process takes place in fluid or gas phase?

2. To investigate how much donor that may be mixed with the injection water and transported during the freezing process?

Methods: The setup was identical to that in Example 1.

In order to investigate the transport process and capacity for potential donors, an inert tracer having the same physical and chemical properties as water (Deuterium/¹⁸O), a chemically inert tracer (Br) isotope and a model donor (molasses) were added to the water in order to investigate the fate of transport. The tracers and molasses were added to the water at the bottom of the clay till and the freezing experiment was repeated with a temperature gradient of −15° C. (top of clay till) to +5° C. (bottom of clay till).

### Results:

Samples were taken in the unfrozen and frozen part of the matrix, and detailed analysis of the water in the matrix was performed.

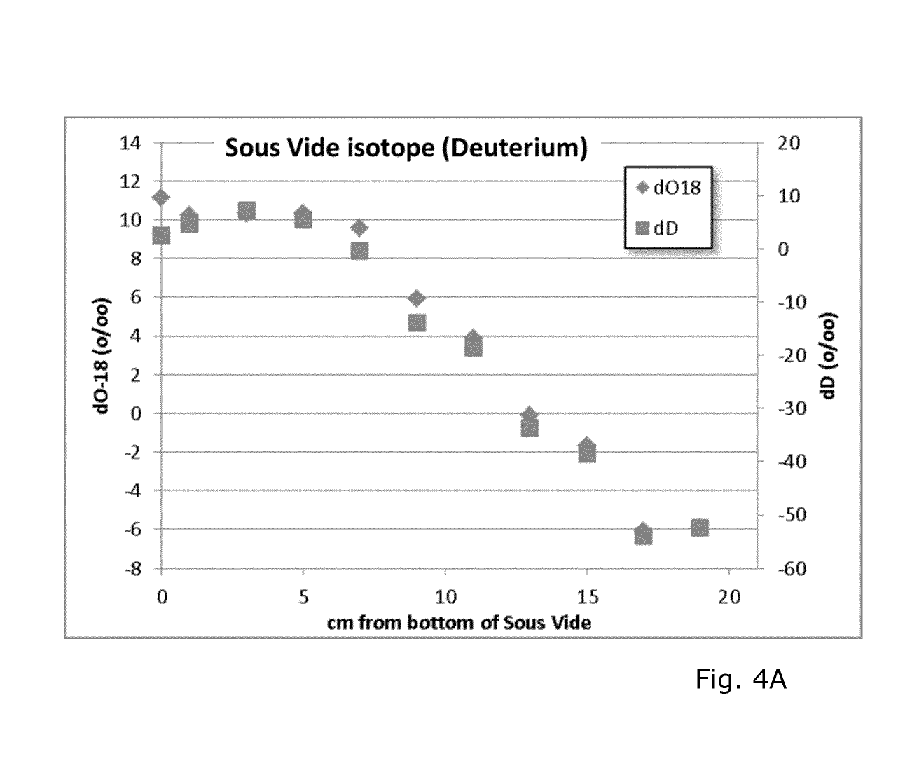

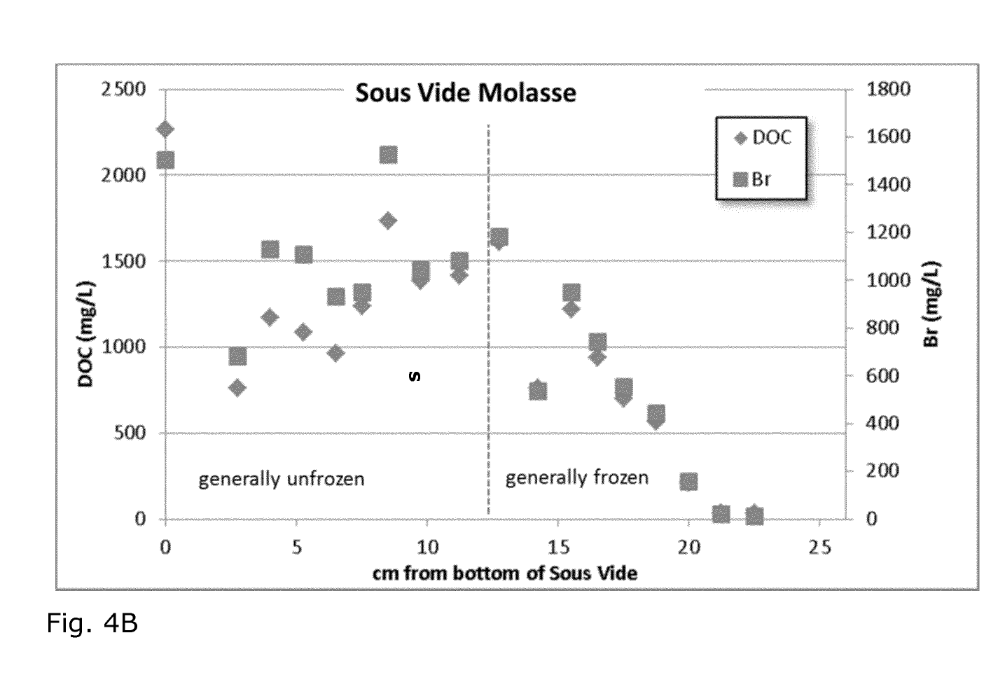

The results showed that all compounds tested are present in the pore water of the clay till and thereby transported in a fluid phase: FIG. 4 shows the concentration of Deuterium/¹⁸O (FIG. 4A) and Molasses and Br⁻ (FIG. 4B) in the matrix sampled on a cross-section of the sample. Results confirm that the substances are transported in a liquid phase.

### Example 3

Experiment with Combined Freezing and Injection of Water/Donor in a Vertical Well Installed in Large Undisturbed Columns of Clayey Till During Compressed and Uncompressed Boundary Conditions.

Rationale/goal: The primary goal of this experiment is to transfer the results and observations from the simulated natural process where soil is frozen from the surface and downwards to an application that may be assigned to a traditional ground freezing technology performed in wells installed in the ground.

At this scale, the application is designed for a large scale laboratory experiment where all the key parameters (temperature, water saturation, injection rate etc.) may be carefully monitored during the experiment.

The primary questions are:

1. What are the shape and size of the ice lenses forming around a freezing steel tube at different temperature gradients? Does the natural sediment fabric influence the shape of the ice lenses and freeze/thaw fractures?

2. How fast does the freezing front migrate at different temperature gradients? This is important information regarding future numerical modelling of optimal temperature ranges for optimal treatment procedures.

3. What is the expansion of the clay till sample? This is important for evaluating potential hazards arising from the “soil heave” that may cause damage to surrounding buildings during a remediation process.

4. How much water is absorbed in the LUC sample? This is important for numerical modelling as a tool for choosing the optimum treatment strategy.

5. What is the gradient of the temperature profiles in the sample? This is important for optimizing the distances between freezing wells.

6. Can compounds be transported from the injection well towards the freezing pipe when an experimental setup resembling an in situ setup is simulated in the laboratory?

### Methods:

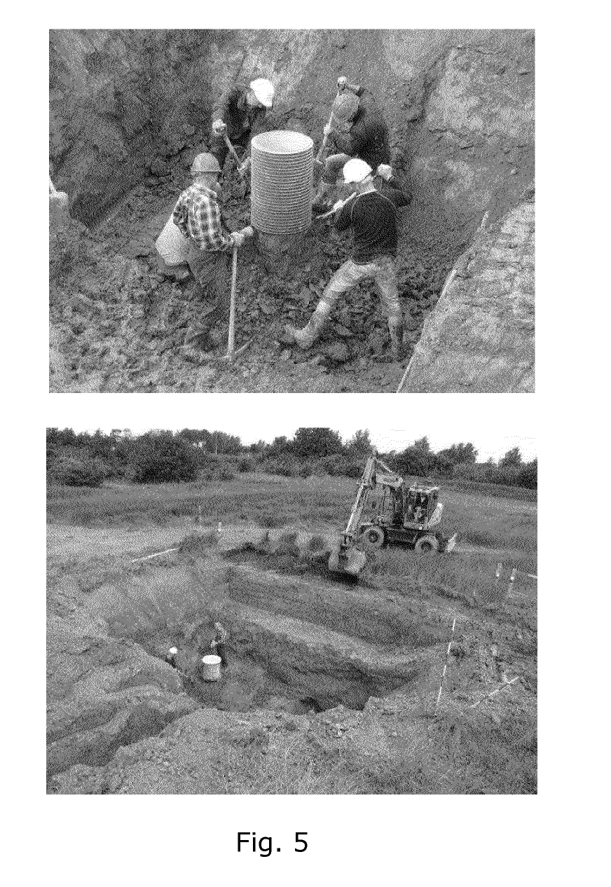

A large column of undisturbed clay till was captured in a large cylinder (50 cm in diameter and 60 cm tall) (FIG. 5). The column was sealed with a rubber membrane and fixed in a steel cylinder with a top and bottom cap.

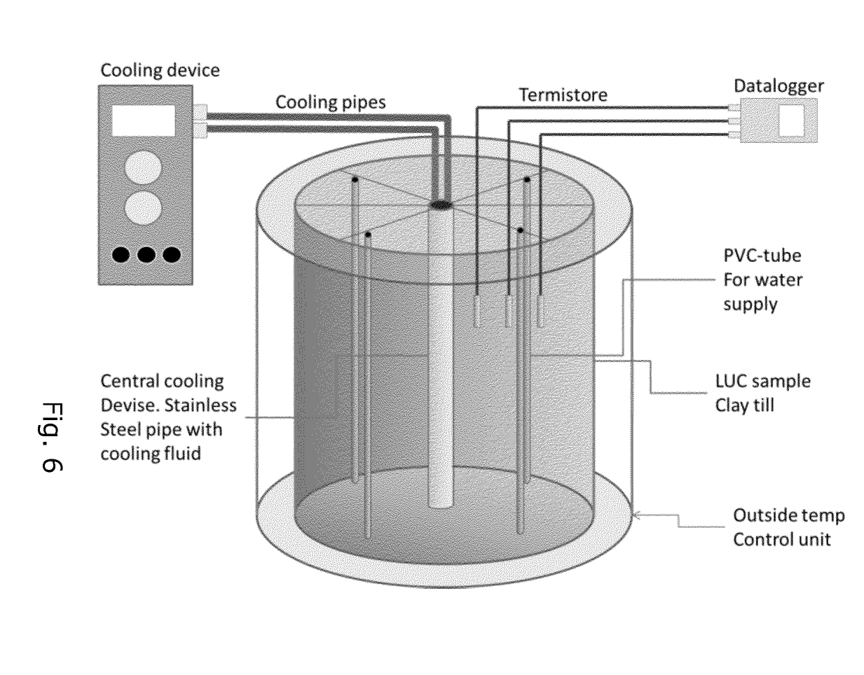

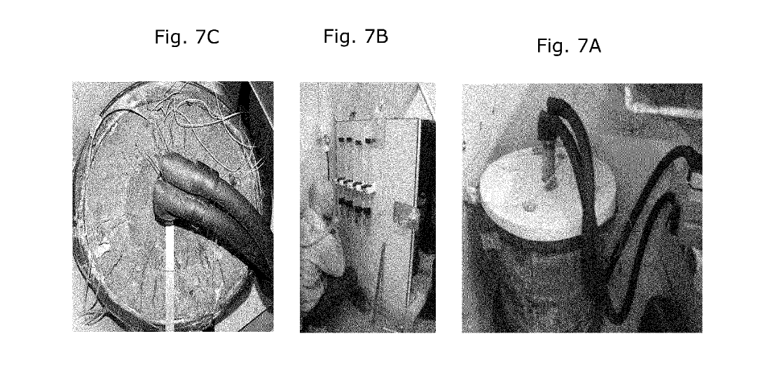

In the laboratory, the clay till column was placed in a cooled box and a central stainless steel pipe (4 cm diameter) was carefully fitted into a central borehole. 4 water addition PVC pipes (16 mm) were installed 5 cm from the margin of the column, and a total of 8 thermosensors (temperature probes) were fitted into the clay at various distances from the central pipe in order to monitor the freezing front. The cooling aggregate was fitted into the steel pipe and an automatic water addition system was constructed for maintaining a constant water level in the water injection pipes. (See FIGS. 6, 7a and 7b).

In the experimental setup, it is possible to maintain a constant temperature in the air surrounding the sample during the freezing experiments thus generating a temperature gradient across the sample.

In the laboratory, the first (LUC1) sample was fitted with a flexible steel skirt (capable of opening in all directions). The sample was initially frozen and the expansion was measured every day as the increase in diameter of the sample. At the same time the temperature in the thermistors was continuously logged and the consumption of water was carefully monitored.

The sample was initially frozen with a core temperature of −5° C. and an outside temperature of +8° C.

The second (LUC2) sample was kept at a constant diameter, thus allowing the clay till sample to expand in the vertical direction only. Otherwise the setup was identical with the LUC 1 sample. However a more variable freezing strategy was tested during this experiment.

### Results

1. What are the shape and size of the ice lenses forming around a freezing steel tube at different temperature gradients? Does the natural sediment fabric influence the shape of the ice lenses and freeze/thaw fractures?

Answer: The primary ice lenses and freeze/thaw fractures form a concentric network of fractures parallel to the freezing front and perpendicular to the general fabric of the clay till (FIG. 7c). A secondary set of radial fractures formed in the unfrozen part of sample due to the general expansion of the inner core of the sample. It may be concluded that the freezing direction controls the formation of concentric fractures in the frozen matrix, while radial fractures are formed due to expansion in the centre if the sample is allowed to expand in all directions. In the LUC2 sample, where the expansion was limited to the vertical direction, the radial fractures were much less developed.

2. How fast does the freezing front migrate at different temperature gradients?

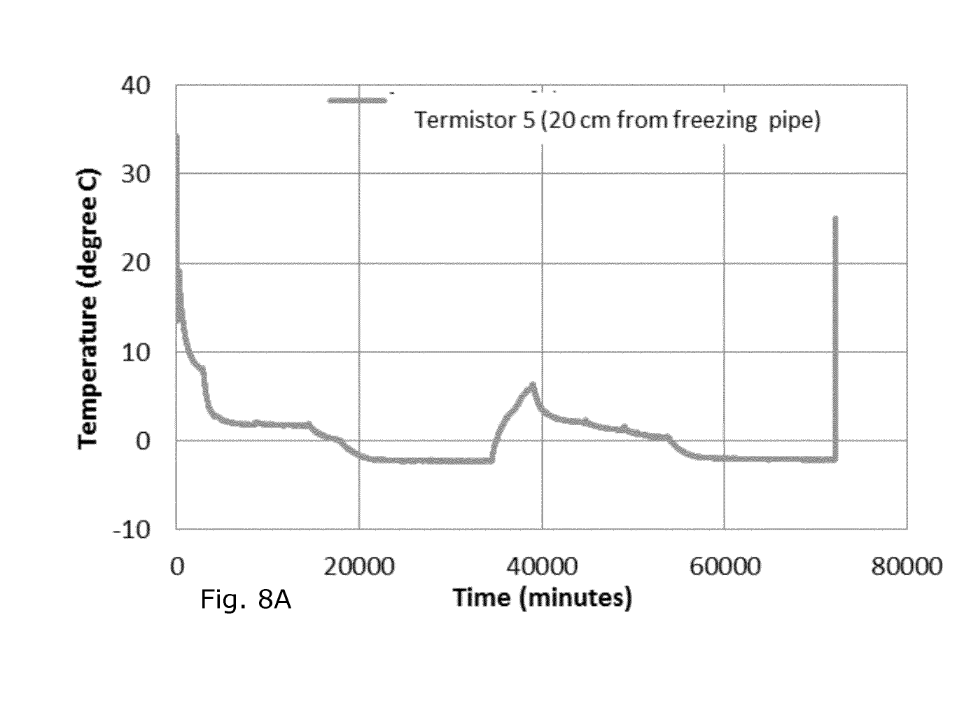

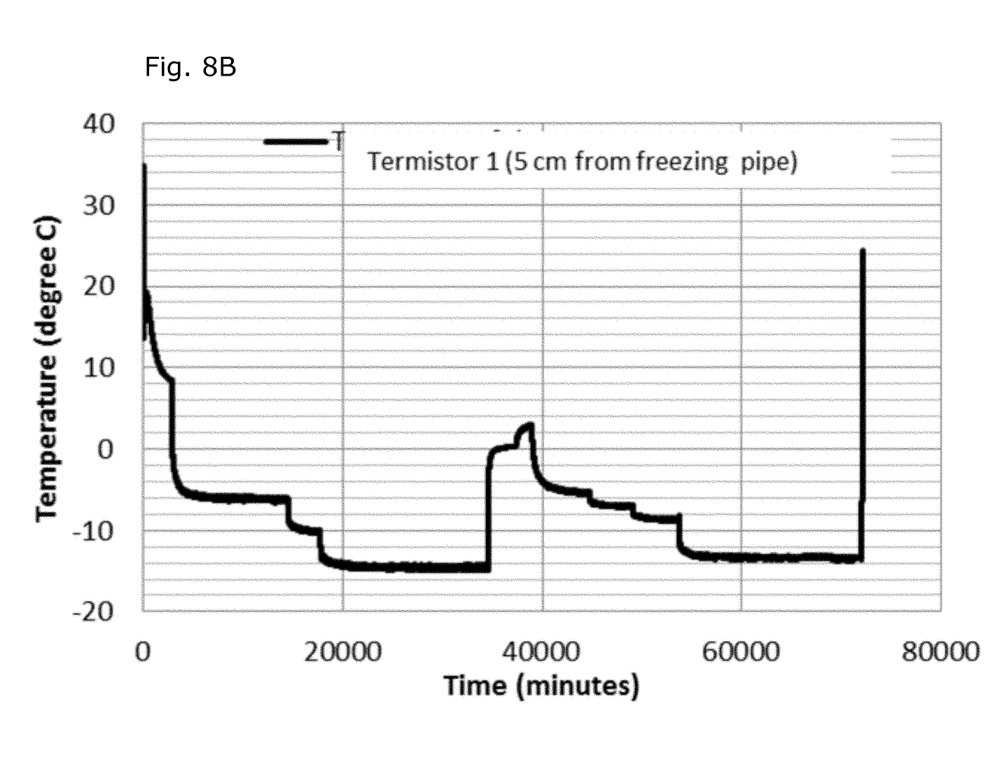

Answer: Equilibrium of the freezing front is obtained within approximately 2-3 days for a temperature gradient corresponding to a change in temperature of 5° C. over a distance of 25 cm from the frozen core (FIG. 8). Generally temperature equilibrium in the LUC sample is obtained rapidly.

3. What is the expansion of the clay till sample?

Answer: The LUC1 (unconfined) sample expanded 14% and LUC 2 (confined) sample expanded 8.1%. This implies that the radial fractures forming in LUC1 also contained water/ice. The vertical expansion under natural conditions is probably smaller; however some frost heave must be expected.

4. How much water is absorbed in the LUC sample?

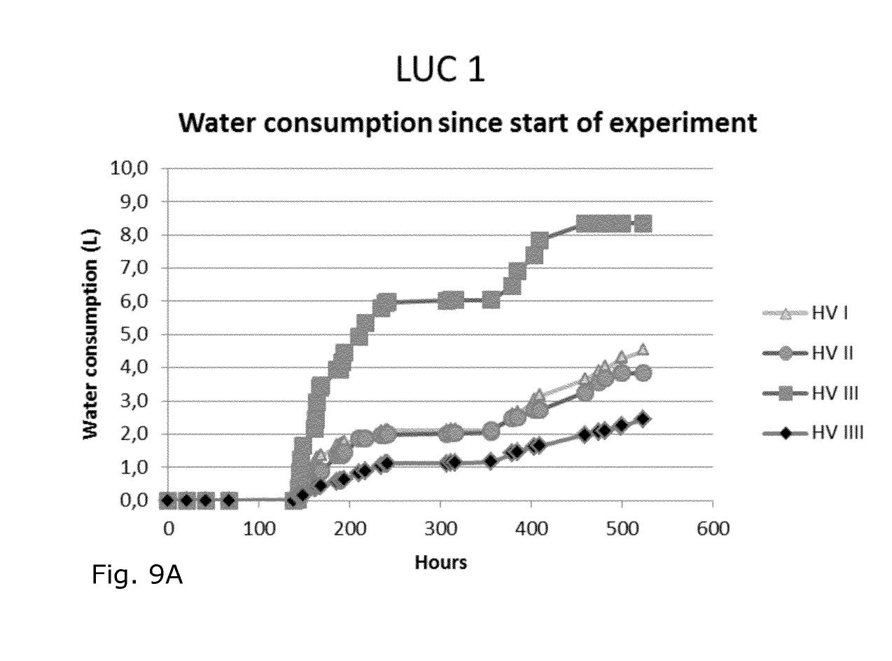

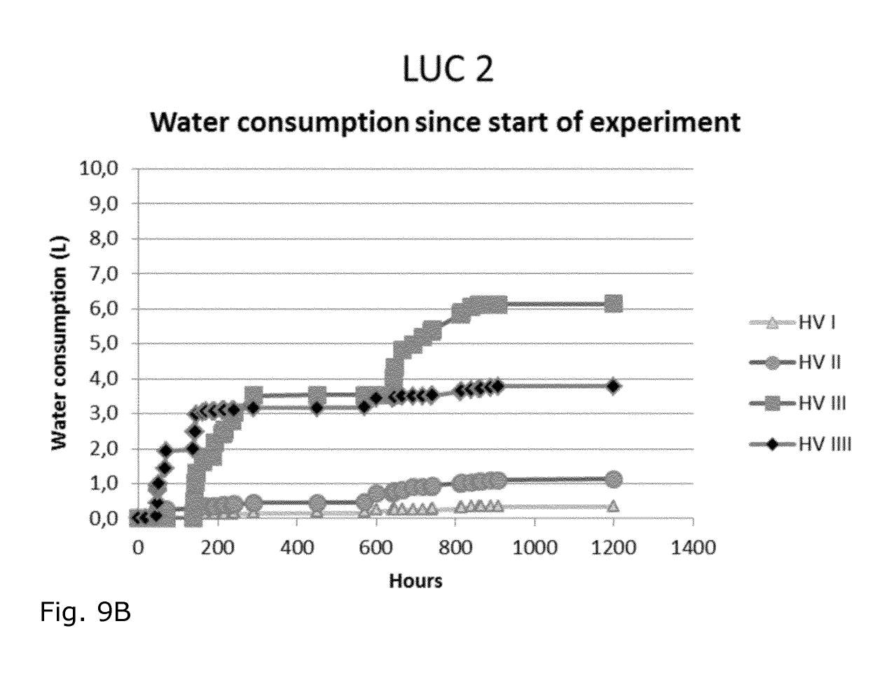

Answer: The LUC 1 sample accumulated 19.16 liters (20%) of water while the LUC 2 sample accumulated 11.39 liters (12%) of water (FIG. 9).

One important result indicates that the transport of fluid from the addition wells is maintained as long as the freezing process is ongoing. This implies that the transport of fluid may be controlled by adjusting the freezing temperature and the duration of the maintenance of the frozen conditions. More experiments are needed in order to more precisely quantify the amount of donor needed for specific remediation.

Generally, the Sous Vide experiment absorbs more water per unit volume of clay than the LUC experiments. This is probably related to the larger contact area between the clay and the water supply in the Sous Vide experiment as compared to the LUC experiment. This implies that the exact design of the liquid supply can be used to influence the rate of liquid absorption and that use of a larger contact area between liquid supply and clay till will provide the possiblitity of an increase in liquid transport; this may e.g. be achieved by using a liquid supply which is formed as liquid permeable panels or a meshwork, which both will have a larger contact area vis-à-vis the surrounding clay than tube-formed pipes.

5. What is the gradient of the temperature profiles in the sample?

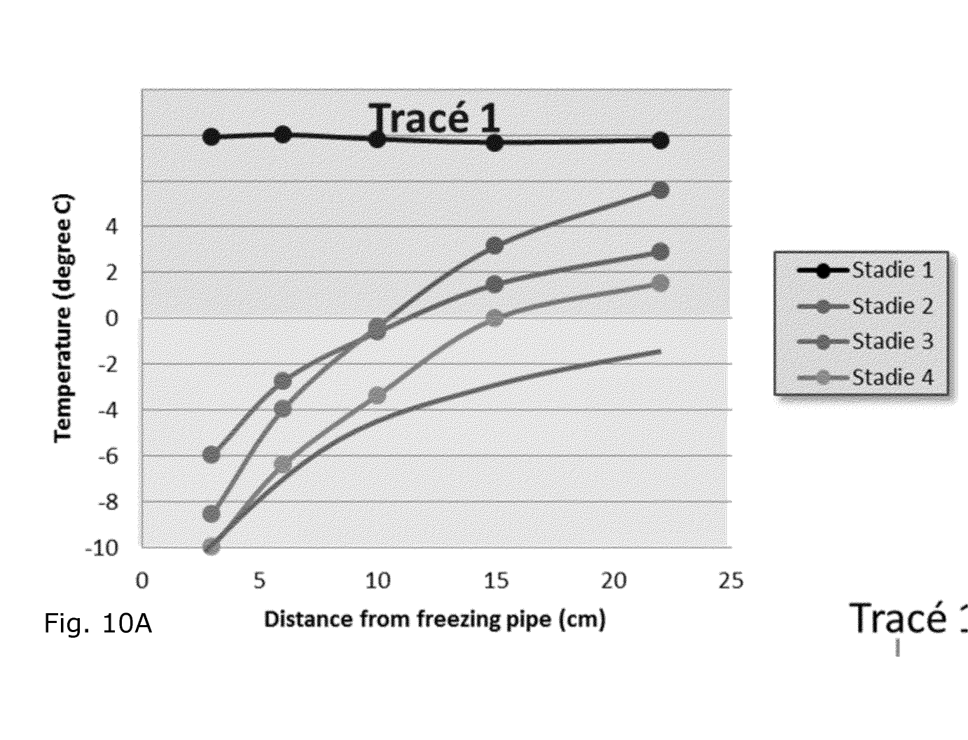

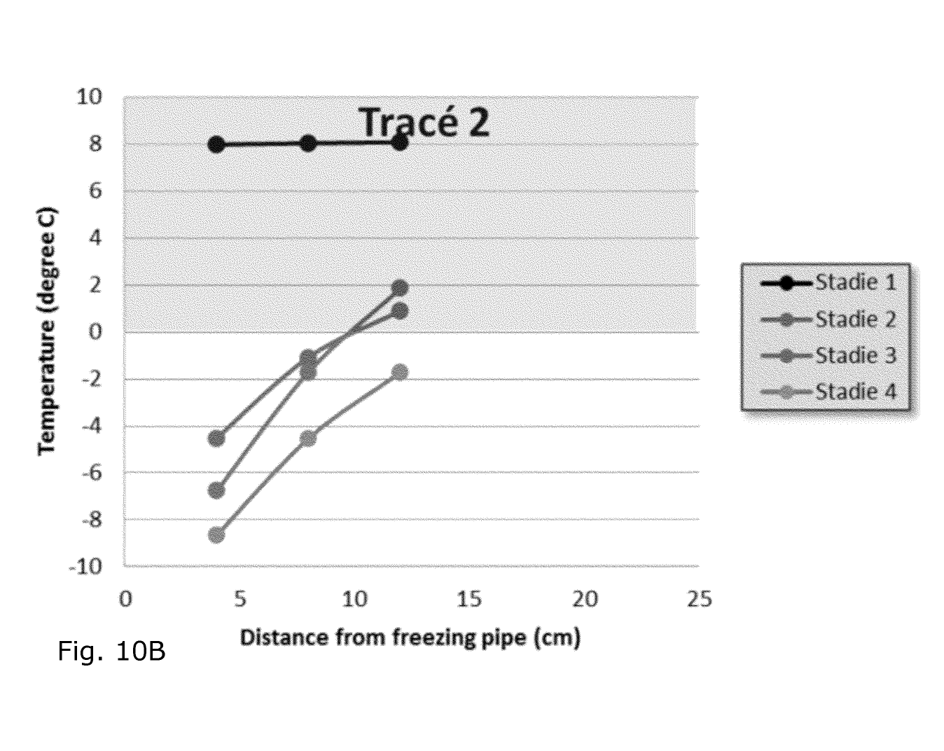

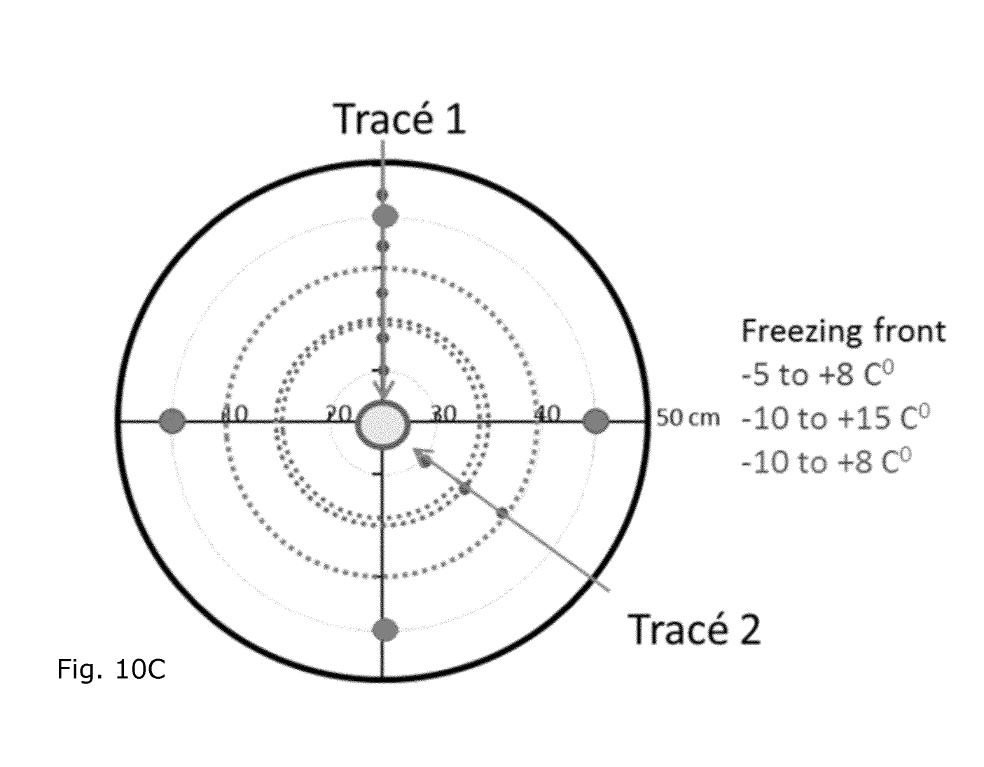

Answer: The curves from three different temp gradients are illustrated in FIG. 10. The gradients suggest that the freezing front may expand more than 1 meter away from the freezing pipe, assuming that the results can be extrapolated to a situation with a temperature close to −30° C. in a subsurface system with surrounding temperature of approximately 8° C.

6. Can compounds be transported rapidly from the injection well towards the freezing pipe?

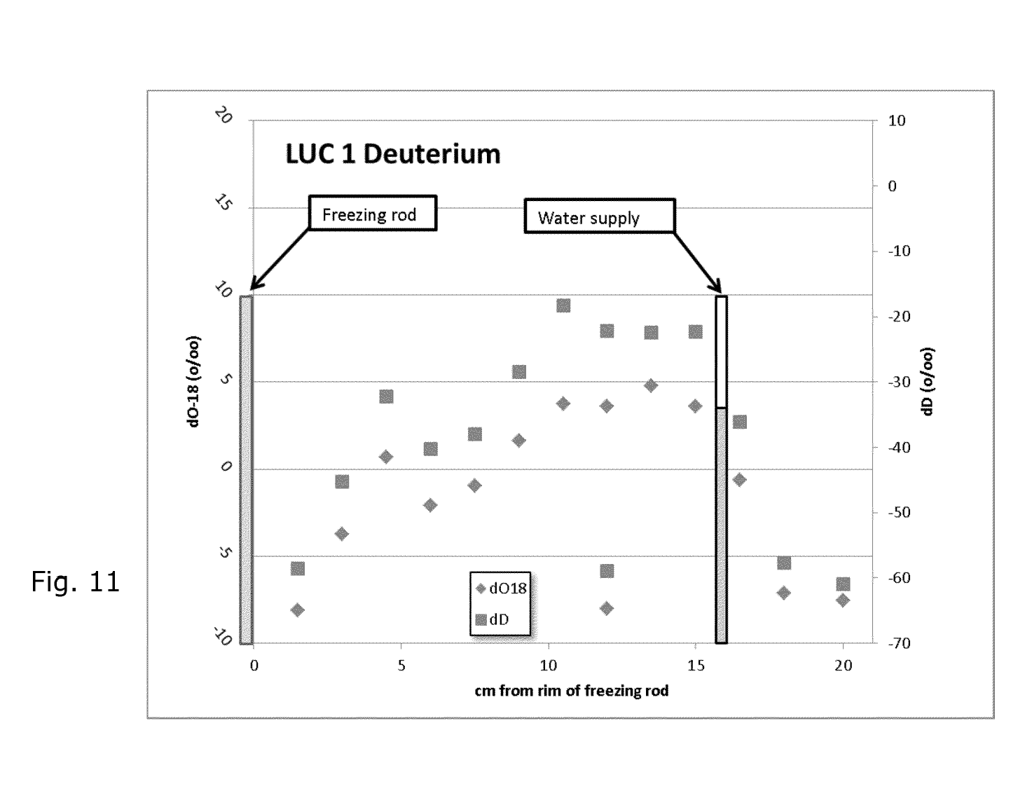

Answer: Definitely. As documented in FIG. 11, the water supply wells distributes rapidly the water and the isotope tracers in the matrix in the direction of the freezing rod/pipe. This documents clearly the efficiency of the transport method to distribute potential donors in a clay matrix between injection wells and a freezing pipe.

### Example 4

Experiment with Combined Freezing and Injection of Water/Donor in a Vertical Well Installed in an Undisturbed Clayey Till Under Natural Conditions.

Rationale/goal: The primary goal of this experiment was to test the application in undisturbed clay till during realistic natural conditions (temperature and saturation) in order to test the ground freezing technology and the injection technology, respectively. This experiment is practical for designing the optimal setup of the soil remediation application, especially the shapes and relative configurations of the freezing and injection wells. That is, the experiment will determine the optimum distance between freezing wells and injection wells as well as the design of the temperature monitoring system. The experiment was furthermore designed to demonstrate how well the donor is distributed in the clay and finally the magnitude of the surface uplift due to “frost heave”.

It is accordingly important to gain knowledge of the following questions:

1. What is the freezing radius at different freezing temperatures during natural conditions in a natural clayey till?

2. How fast is the freezing front migrating?

3. What is the capillary “suction” radius around the freezing well under natural conditions in a natural clayey till?

4. What is the water/donor consumption during unsaturated conditions in a natural clayey till?

5. How is the donor distributed between the injection wells and the freezing wells?

6. How large is the surface uplift “frost heave”? Methods:

In order to investigate the above questions a field experiment was carried out on a clay till site on a field nest to Kallerup Gravelpit near the town of Hedehusene in Denmark. This is the same location that was used to collect intact samples of sandy clay till for the “Sous Vide” experiments of Example 1. The area consists of approximately 10 meters of sandy clay till overlying a sandy aquifer. The till has been classified as a basal till formed underneath a glacier transgressing the area approximately 16,000 years ago. This till covers the majority of Zealand and is representative for vide areas in Denmark. The till is generally sandy and at depth several sand stringers and minor sand lenses are present, the till is unsaturated since it is situated close to the gravel pit, where the groundwater table is kept constant approximately 12 meters below ground surface. However a secondary groundwater table exists at various depths during wet periods. An area of 10×10 metres was prepared for the experiment, and the topsoil was removed in order to perform the experiment in the depth of 3-4 metres below natural ground surface.

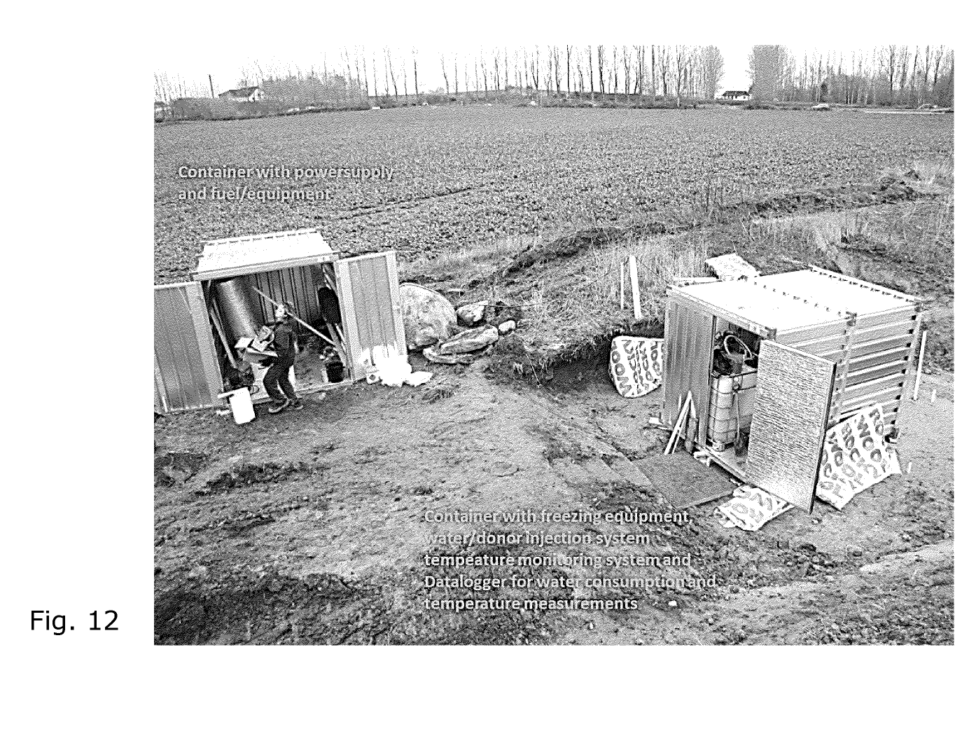

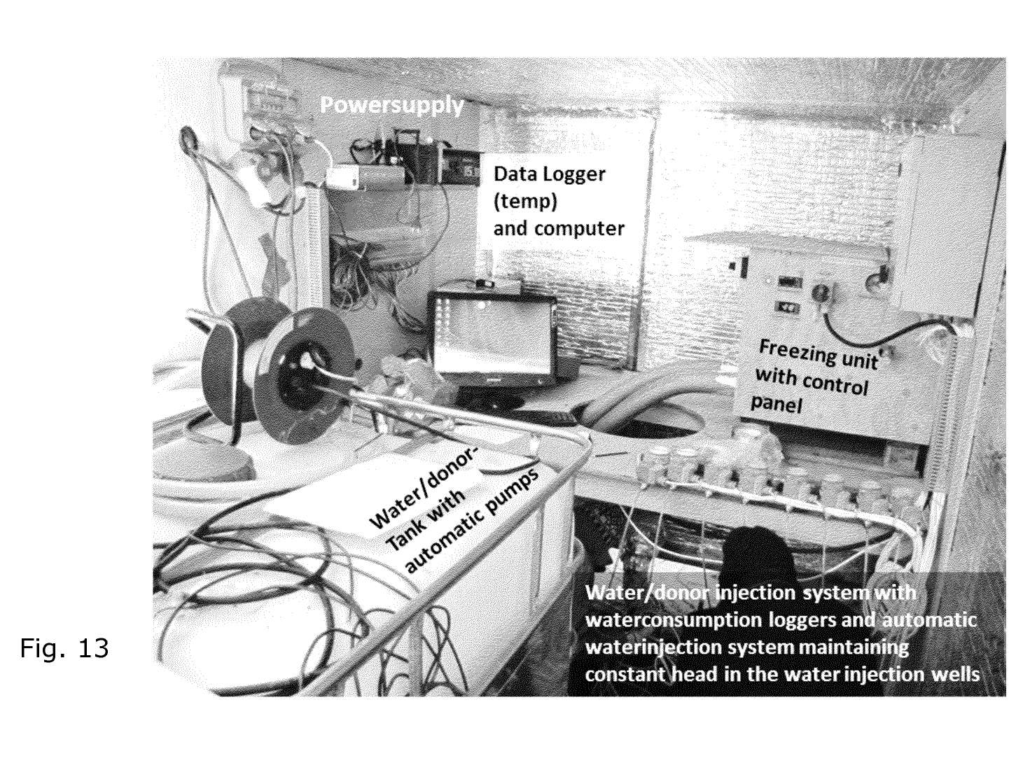

The freezing equipment from the LUC experiments were mounted in a Container together with a 1000 litre tank and a Liquid injection system capable of monitoring the amount of water injected into the wells. Finally a temperature monitoring system was constructed, and a second container containing the power supply and fuel was placed next to the other container (See FIGS. 12 and 13).

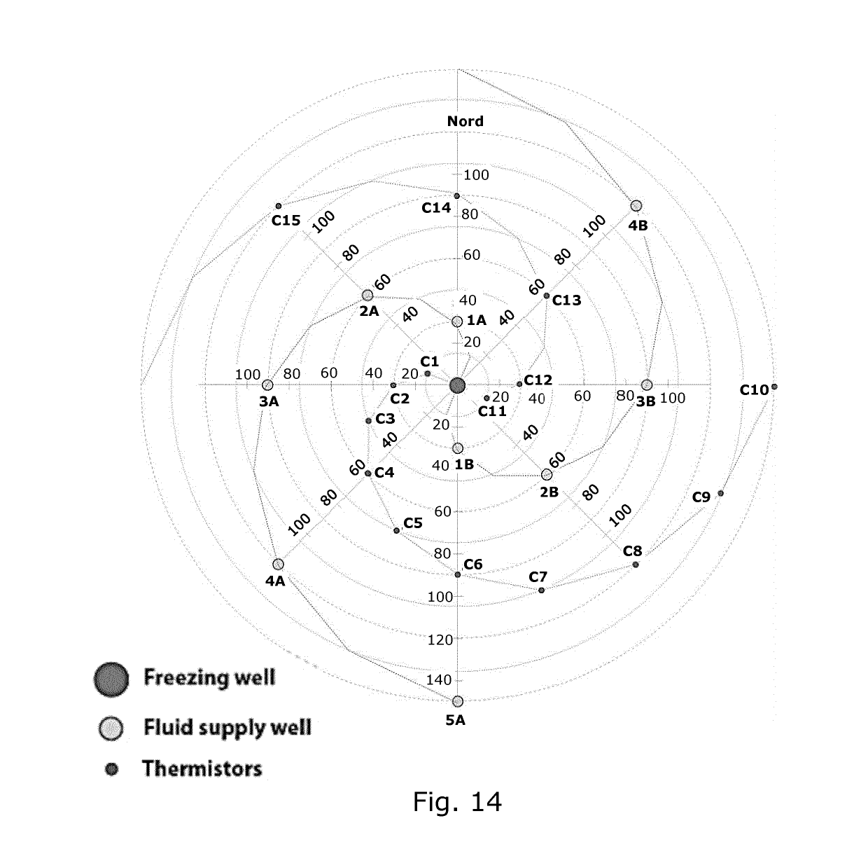

A configuration of 9 injection wells (1A-5A and 1B-4B) and 15 thermistors were installed around a central freezing well, in a pattern we name as the “galaxy” configuration due to the shape of the configuration (see FIG. 14). A special device capable of maintaining a constant head 25 cm below ground surface was installed in the injection wells.

The depth of the freezing well was 3 meter and the freezing took place in the depth interval from 0.5 to 2.5 m below ground surface. The thermistors were installed at a depth of 1.5 m below ground surface.

The container was placed over the wells and everything was covered with mats in order to prevent frost action from the outside.

The experiment took place over a period of 24 days in November and December 2014. Initially the soil was saturated with water for three days. A Bromide tracer was mixed with the water in order to measure the distribution afterwards. After 3 days the freezing started with a freezing temperature in the well of −8° C. Then the temperature was lowered to −12° C., −16° C., −20° C., and −24° C. in cycles of 3 days. Finally −24° C. was maintained during the rest of the period.

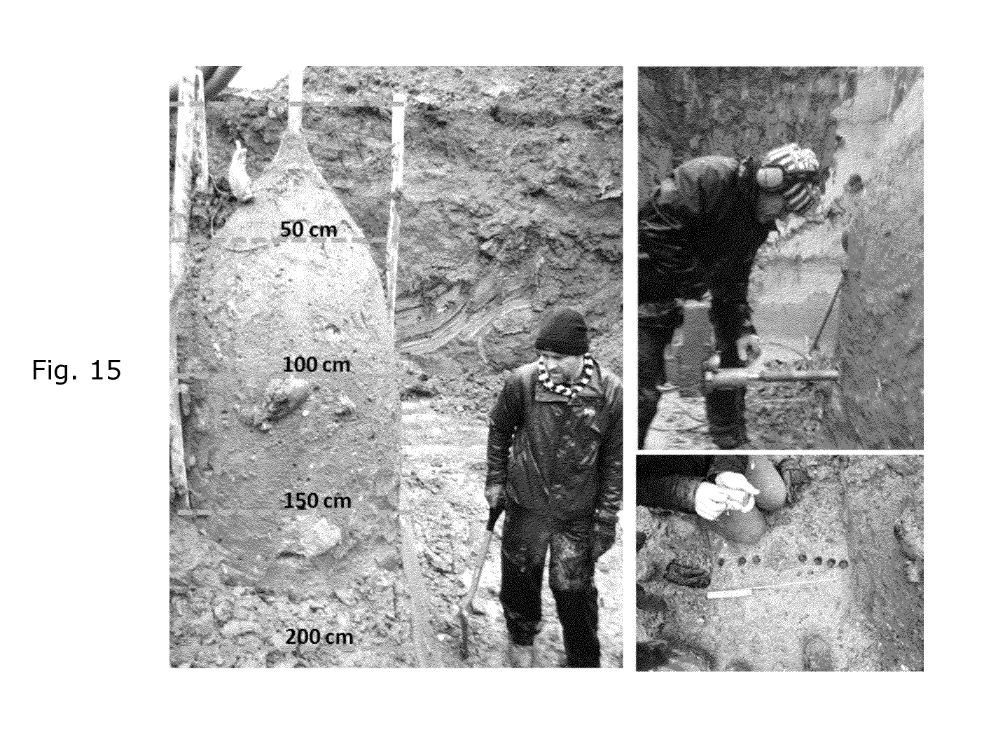

After the experiment was concluded, the container was disconnected from the wells and removed. The entire experiment was then excavated and detailed sampling of soil samples for analysing the bromide content was carried out (FIG. 15).

The injection rate as well as the temperature record was monitored on data loggers and stored in a computer. Also the uplift of the subsurface was monitored before and after the conclusion of the experiment. Finally the fuel consumption was recorded in order to get an estimate of the energy consumption.

The soil samples were analysed in the laboratory and data was analysed in order to get an answers to the questions above.

### Results

1. What is the freezing radius at different freezing temperatures during natural conditions in a natural clayey till?

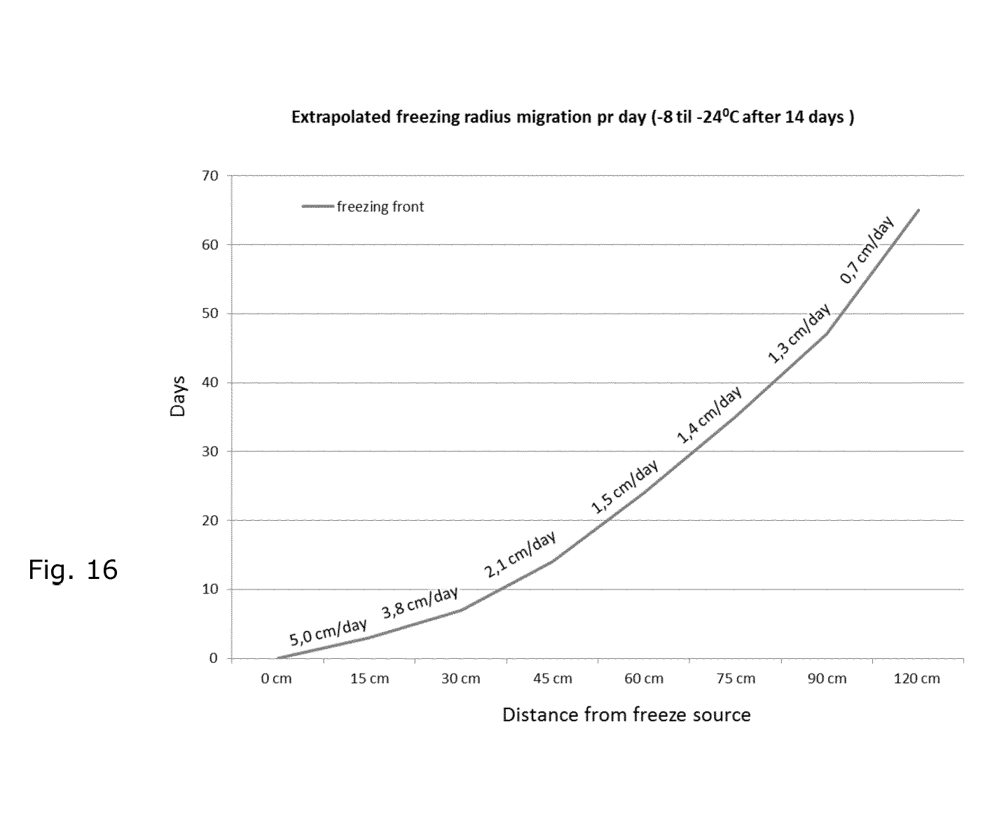

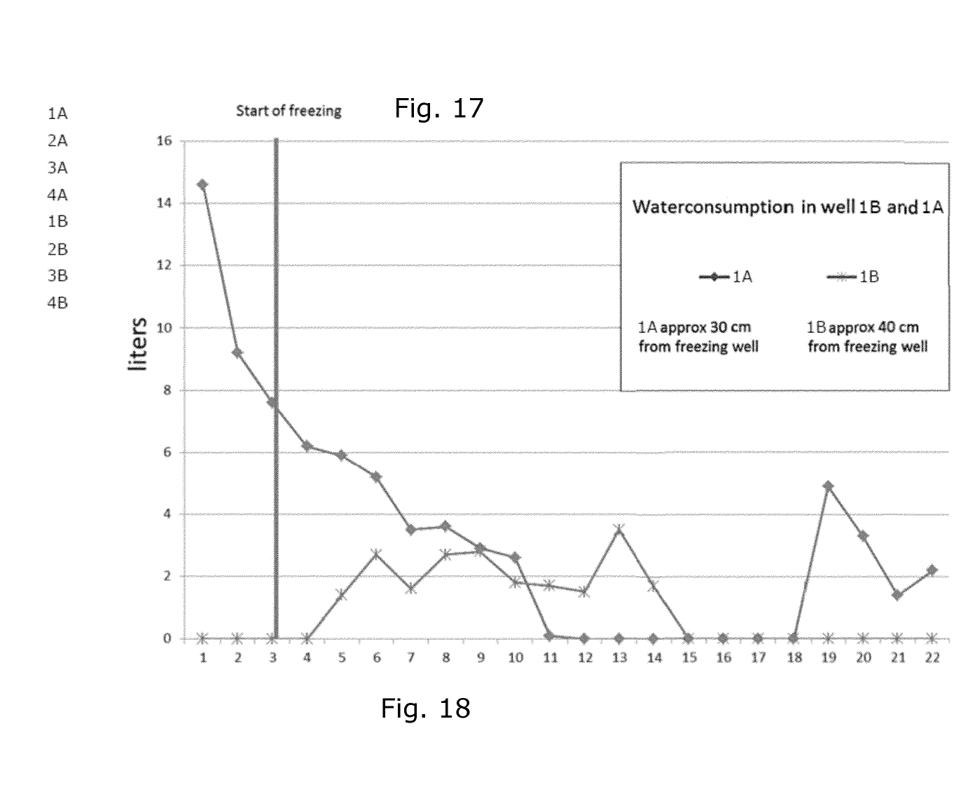

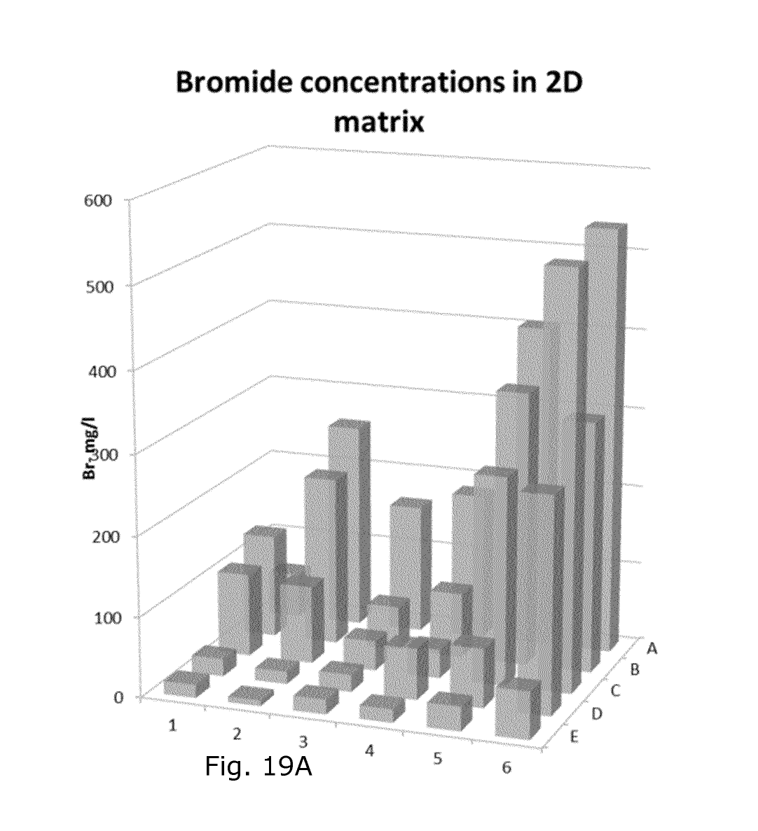

Answer: The freezing radius at freezing temperatures of −24° C. may exceed 75 cm after 1 month. However, a radius of more than 120 cm may take more than 2 months to achieve. In FIG. 16, a freezing curve based on the observations has been constructed.

2. How rapidly is the freezing front migrating?

Answer: With a starting temp at −8° C., the freezing front is migrating between 7-4 cm the first day and less than 2 cm/day after 3 days. After 4 days the temp is lowered to −12° C. and the migration speed is stabilized to approximately 2 cm/day by lowering the temp 4° C. every 3 days. After 13 days the temperature is kept constant at −24° C. causing the migration speed to gradually decrease to approximately 1.5 cm/day after 24 days. By interpolating the freezing curves it is estimated that the migration of the freezing front will decrease to less than 0.7 cm/day after 65 days at a radius of 120 cm from the freezing source (see FIG. 16).

3. What is the capillary “suction” radius around the freezing well under natural conditions in a natural sandy clayey till?

Answer: Based on the freezing curves and the time injection well 1B was frozen, the distance between the freezing well and the injection well 1B must have been approximately 40 cm, and injection well 1A must have been close to 30 cm from the freezing well. The injection wells were activated after approximately 1 day of freezing, implying that the freezing front had only migrated a short distance and that the process started almost instantly. In turn, this implies that the “suction radius” is >40 cm. However this is based on one observation only. More experiments are required to estimate the suction radius in a larger number of different clayey tills, since the “Sous Vide” experiments have documented a rather significant difference in different till types.

4. What is the potential water/donor consumption during artificial saturated conditions in a natural sandy clayey till?

Answer: Due to the heterogeneous nature of the clay till that was partly perforated by sand lenses, most of the injection wells were leaking fluid to the subsurface during the experiment except for one well (1B). A total of 1345 litres of water was injected during the 24 days. In the beginning of the experiment approximately 80 litres were injected every day. This amount decreased rapidly to less than 20 litres per day during a period of heavy rain. Accordingly the drainage is influenced by the precipitation. It is therefore difficult to estimate the amount of water/tracer that was accumulating in the frozen block.

However, well 1B was not draining water in the initial phases of the experiment and it is therefore assumed that all the water from this well migrated towards the freezing front. During the 11 days the well was active a total of 21.4 litres were added before the well froze. This is an average of approximately 2 litres per day along a 2 meter long filter.

A1 clearly had a secondary drainage path that was decreasing as the soil froze, however 1A was consuming almost the same amount as 1B just before it froze. The wells more distant from the freezing point were all draining large amounts of water/tracer to the subsurface, and they were all highly influenced by the precipitation, which makes it difficult to estimate the potential contribution to the freezing front. It is likely that the results would have been quite different at another location with massive clay till and less drainage to sand lenses.

One conclusion drawn is that it is recommended that the site is covered with a tarp during the freezing experiment and that potential precipitation is redirected away from the site in small channels, in order to have better control on the water drainage and to avoid dilution of the tracer. Further experiments are required to predict the water consumption more accurately.

5. How is the donor distributed between the injection wells and the freezing wells?

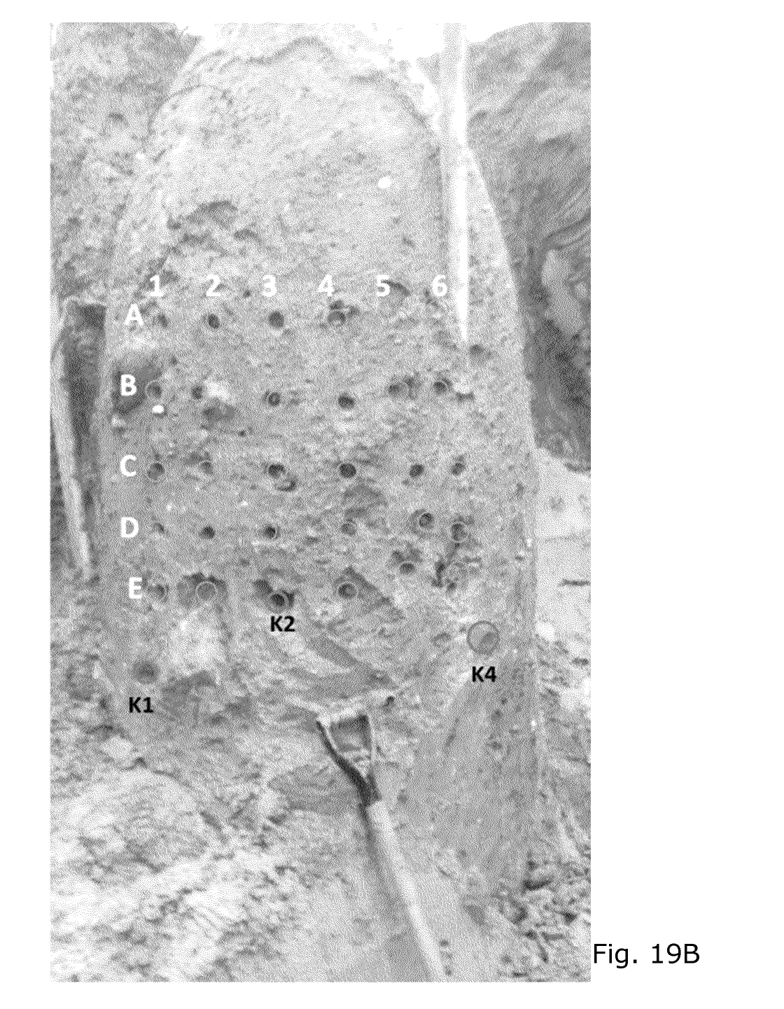

Answer: After the experiment was completed, the frozen block was excavated to a depth of 2.5 metres below ground surface. Samples were collected at small transects outside the frozen block and inside the block using a hand hold drill. K1 and K2 were taken far from injection wells and one (K4) close to injection point 1A. 30 samples were taken from the surface of the block as it thawed (See FIG. 19, right panel).

Generally it is documented that the clay till block is partly saturated with the Bromide tracer. It is clearly possible to enhance the injection of a tracer into (in this case) a sandy clay till. The Sous Vide experiments indicate that a more clay-rich till would be even more saturated.

However the concentrations vary to a large extend from small concentrations to very large concentrations (See FIG. 19, left panel) and it may be concluded that the distribution may be influenced by several factors such as presence of sand lenses, amount of precipitation, distance between injection wells and finally also the clay content of the till.

6. How large is the surface uplift “frost heave”?

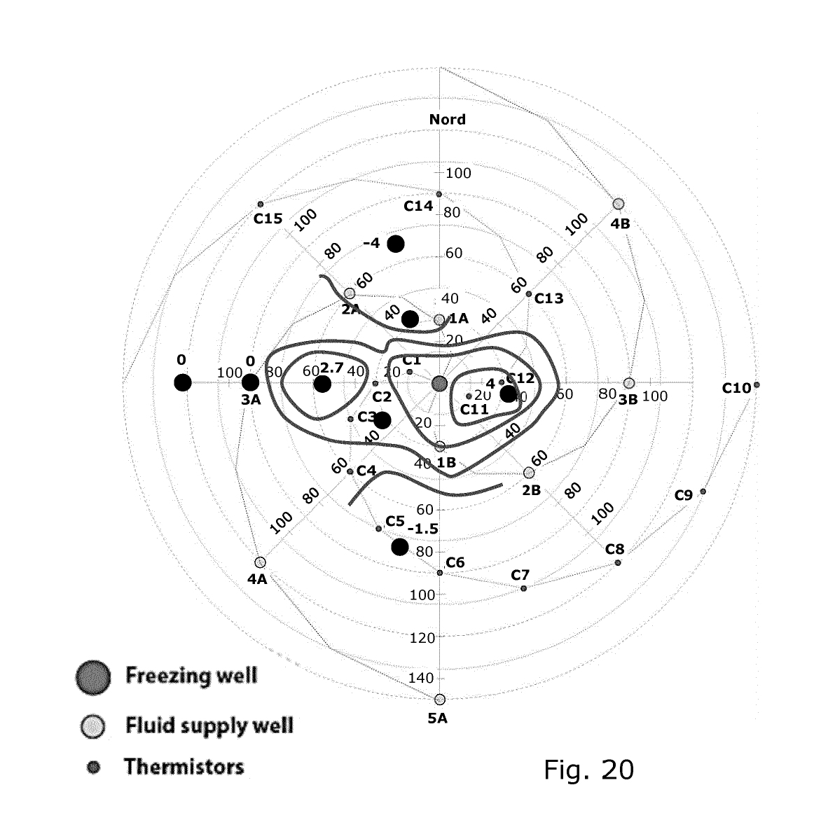

Answer: The uplift was monitored and during the 3 weeks of freezing only a minor uplift of 4 cm at one point close to the center was observed (see FIG. 20, which shows the elevation pattern). Some radial fractures were visible close to the surface and it is suggested that the reactivation of A1 is related to such a fracture, as the water in the uppermost unfrozen 0.5 metres may have drained into these fractures from well A1. Outside the central uplift a minor subsidence was observed.

### Example 5

Experiment with Combined Freezing and Injection of Water/Donor in a Configuration of Vertical Wells Installed in a Full Scale Remediation Experiment in a Typical Contaminated Clayey Till Site.

Rationale/goal: The primary goal of this experiment is to test the application in a contaminated site dominated by clay till, in order to test the ground freezing technology and the injection technology. This experiment will be used for designing the optimal setup of the remediation application, especially the configuration of the freezing and injection wells as well as the temperature monitoring system.

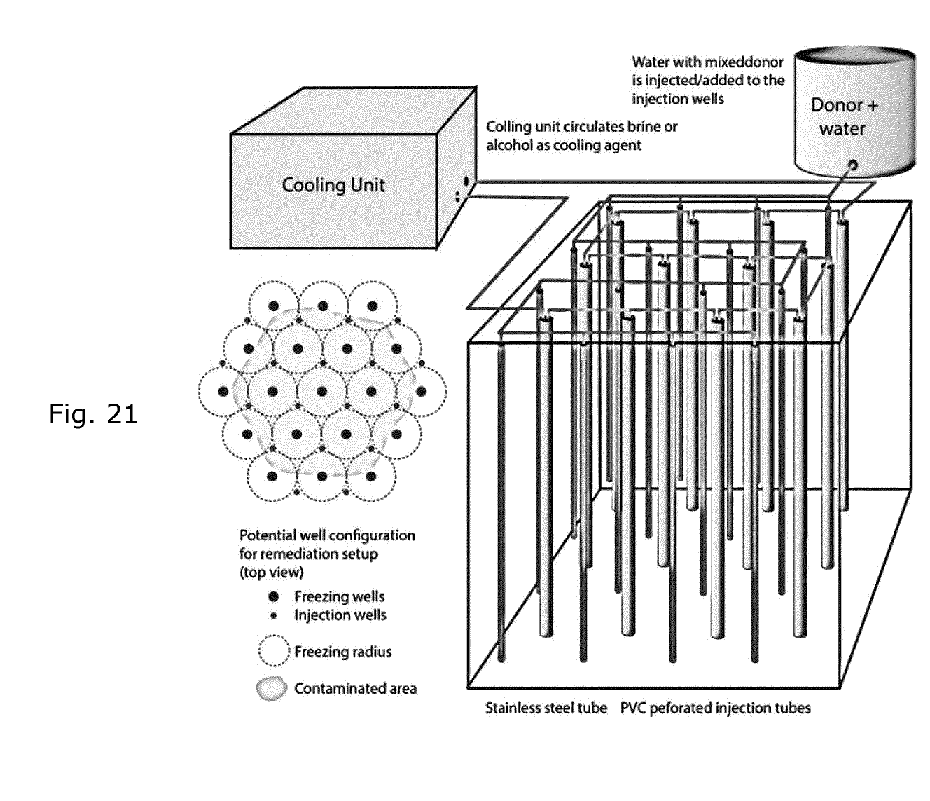

This experiment utilises a plurality of vertical wells of which some are equipped with freezing elements and other wells are designed to deliver the liquid to the soil. A schematic depiction of the setup is provided in FIG. 21. The exact geometry of the “wells” may deviate from that schematically shown in FIG. 21—as mentioned above, it may eventually turn out that an arrangement of multiple parallel freezing panels and multiple parallel water supply panels will provide the optimum transport conditions for an aqueous solution.

1. A method for distributing a liquid medium into a volume of a porous medium, which has a matrix hydraulic conductivity below 10⁻⁷ m/s, comprising establishing at least one frozen section and at least one non-frozen section of said volume and introducing said liquid into said non-frozen section.

2. The method according to claim 1, wherein said volume comprises or consists of clay or clay-rich material.

3. The method according to claim 1, wherein said frozen section is established by means of at least one freezing unit introduced directly into said volume.

4. The method according to claim 1, wherein said liquid medium is introduced while the at least one frozen section is being established.

5. The method according to claim 1, wherein said liquid medium is introduced after the at least one frozen section has been at least partially established.

6. The method according to claim 1, wherein the volume of said frozen section expands as a consequence of being frozen.

7. The method according to claim 6, wherein volume expansion is at least 3%

8. The method according to claim 6, wherein the capacity for the liquid medium in the frozen section increases as a consequence of volume expansion of said frozen section.

9. The method according to claim 1, wherein the frozen section, which is established, comprises freeze-thaw fractures that are spaced with an average distance of at most 10 cm.

10. The method according to claim 1, wherein said liquid medium is introduced into the non-frozen section at elevated pressure.

11. The method according to claim 1, wherein said liquid medium moves from its point(s) of introduction in the at least one non-frozen section in the direction of the at least one frozen section.

12. The method according to claim 11, wherein movement of said liquid is mainly driven by capillary forces in said non-frozen section.

13. The method according to claim 1, wherein a plurality of frozen sections are established and/or wherein a plurality of non-frozen sections are established.

14. The method according to claim 13, wherein the distance between the point of introduction of said liquid and the nearest frozen section is at least 30 cm.

15. The method according to claim 1, wherein said at least one frozen section is cylindrical.

16. The method according to claim 1, wherein at least one frozen section is wall-shaped and optionally, if more than one frozen section is established, separated from other non-frozen sections by wall shaped non-frozen sections.

17. The method according to claim 16, wherein wall-shaped sections form closed walls, e.g. concentric cylindrical walls, or form spaced open walls, e.g. parallel walls.

18. The method according to claim 1, wherein said liquid is aqueous.

19. The method according to claim 1, wherein said liquid medium further comprises a donor substance or composition.

20. The method according to claim 19, wherein said donor substance or composition is selected from microorganisms such as bacteria, enzymes, catalysts, nano-particles such as nano iron, oxidizing agents such as permanganates, salts, hydrocarbons such as water-soluble carbohydrates.

21. The method according to claim 1, wherein said volume is a volume of soil or low permeable sediment or biogenic rock or porous crystalline rock.

22. The method according to claim 1, which is performed in order to facilitate remediation of soil, or to transport substances into said volume, optionally with a view to solidifying said volume.

23. The method according to claim 1, comprising at least two separate rounds, wherein at least one subsequent round establishes 1) at least one frozen section in a part of the volume that constituted a non-frozen section in the previous round and 2) at least one un-frozen section in a part of the volume that constituted a frozen section in the previous round.

24. The method according to claim 1, wherein said volume of a porous medium is protected from incoming hydration from natural sources such as hydration caused by precipitation.

25. The method according to claim 24, wherein protection is effected by covering the surface exposed part of said volume.

26. A method for reducing the concentration of polluting material in a volume of a porous medium, which has matrix hydraulic conductivity below 10⁻⁷ m/s, comprising distributing a liquid medium in said volume according to claim 1 for a period of time sufficient to reduce the concentration of the polluting material to a predetermined value.

27. The method according to claim 24, wherein reduction in concentration of said polluting material is facilitated by a donor substance or composition.

28. A system for introducing a liquid medium into a volume of a porous medium, which has matrix hydraulic conductivity, such as below 10⁻⁷ m/s, said system comprising
at least one freezing unit inserted into said volume and being capable of establishing a frozen section of said volume,
at least one delivery means inserted into said volume and being adapted to supply a liquid medium into a non-frozen section of said volume while a section of said volume is frozen in a section comprising said at least one freezing element,
at least one first temperature gauge inserted into said volume in close proximity to said at least one freezing element, and
at least one second temperature gauge inserted into said volume in close proximity to said at least one delivery means.

29. The system according to claim 28, which comprises a plurality of freezing units and/or a plurality of delivery means.

30. The system according to claim 28, wherein said freezing unit(s) constitute(s) part of a closed controlled circuit, which can maintain a predetermined temperature below freezing point of said freezing unit(s) and the surrounding volume and which can maintain a temperature above freezing point in medium surrounding said delivery means in response to temperature measurements from said at least one first and second temperature gauges.

31. The system according to claim 28, wherein said freezing units are in the form of pipes, panels, or a meshwork, optionally inserted vertically into said volume.

32. The system according to claim 28, wherein said delivery means are in the form of perforated pipes, perforated panels, or a perforated meshwork, optionally inserted vertically into said volume.
